(19) United States
(12) Patent Application Publication
(10) Pub. No.: US 2026/0045622 A1
(43) Pub. Date: Feb. 12, 2026

(54) BATTERY CHARGING CASE

(71) Applicant: Shenzhen Obuy Technology Co., Ltd, Shenzhen (CN)

(72) Inventors: QI YUAN, Shenzhen (CN); OU YANG, Shenzhen (CN); MANCHUN CAI, Shenzhen (CN); ZIYANG ZHOU, Shenzhen (CN)

(21) Appl. No.: 19/016,007

(22) Filed: Jan. 10, 2025

(30) Foreign Application Priority Data
Aug. 7, 2024 (CN) 202411074330.5

(51) Int. Cl. H01M 50/269; H01M 10/44; H01M 10/46; H01M 50/244

(52) U.S. Cl. CPC H01M 50/269; H01M 10/441; H01M 10/46; H01M 50/244

(57) ABSTRACT

The present application discloses a battery charging case, the battery charging case includes a feeding module, a charging module, and a discharging module. The charging module includes a charging compartment, a screening assembly, and a classification assembly; the charging compartment includes a first bracket and a second bracket; the first bracket includes a battery installation through slot for accommodating the batteries to be charged; the screening assembly is configured to move along the width direction of the battery charging case to screen the batteries to be charged which fall into the battery installation through slot; the second bracket includes a channel for the circulation of the fully charged batteries as well as waste batteries; the classification assembly is configured to transfer the plurality of fully charged batteries as well as waste batteries flowing out of the channel to different areas.

### CROSS-REFERENCE TO RELATED APPLICATIONS

This application claims priority to Chinese Patent Application No. 202411074330.5, filed on Aug. 7, 2024, which is hereby incorporated by reference in its entirety.

### TECHNICAL FIELD

The present application relates to the field of battery charging technology, particularly to a battery charging case.

### BACKGROUND

The battery charging case is used to charge the batteries to be charged. Understandably, the batteries to be charged include, but are not limited to, the batteries to be charged that meet the model requirements and the batteries to be charged that do not meet the model requirements; wherein the batteries to be charged that meet the model requirements include the batteries to be charged that meet the model requirements and are not damaged and the batteries to be charged that meet the model requirements and have been damaged.

The battery charging case can only charge the batteries to be charged that meet the model requirements and are not damaged. However, the battery charging cases in related technologies are structurally simple, for example, they can neither effectively store the batteries to be charged, nor effectively screen the batteries to be charged, nor effectively store the fully charged batteries, and such a single function is not convenient for the user to use. Therefore, how to effectively improve the functional diversity of the battery charging case to facilitate the use of the user has become an urgent problem.

### SUMMARY

The present embodiment provides a battery charging case, which can solve the problem that the battery charging case in related technologies is simple structurally and thus has a single function that is not user-friendly.

The present embodiment provides a battery charging case; the battery charging case comprises a feeding module, a charging module, and a discharging module. The feeding module is used to accommodate a plurality of batteries to be charged. The charging module is used to charge the plurality of batteries to be charged, the charging module comprises a charging compartment, a screening assembly, and a classification assembly; the charging compartment comprises a compartment body, a first bracket, and a second bracket; a feeding port of the compartment body is connected to a discharging port of the feeding module; the first bracket is installed in a chamber of the compartment body and comprises a battery installation through slot for accommodating the plurality of batteries to be charged; the screening assembly is installed on the first bracket and is located at a discharging side of the battery installation through slot, the screening assembly is configured to move along a width direction of the battery charging case to screen the plurality of batteries to be charged which fall into the battery installation through slot; the second bracket is installed in the chamber of the compartment body and is detachably connected to the first bracket, the second bracket is further away from the feeding port of the compartment body than the first bracket and comprises a channel for the circulation of a plurality of fully charged batteries as well as waste batteries, the channel is located below the battery installation through slot; the classification assembly is configured to transfer the plurality of fully charged batteries as well as waste batteries flowing out of the channel to different areas; a discharging module is used to accommodate the plurality of fully charged batteries, a feeding port of the discharging module is connected to a discharging port of the charging module.

Based on the battery charging case in the embodiment of the present application, by designing the feeding module, the feeding module is capable of effectively storing the battery to be charged. By designing the charging module, the charging module is capable of effectively charging the batteries to be charged; by designing the first bracket, the first bracket provides support for the screening assembly, which moves in the width direction of the battery charging case to effectively screen the batteries to be charged that fall into the battery installation through slot; by designing the second bracket, the second bracket provides support for the classification assembly, which switches between a first classification state and a second classification state to effectively sort the fully charged batteries and the waste batteries; by designing the second bracket and the first bracket in a split structure, it is easy to install and remove the screening assembly from the first bracket, and it is easy to realize the installation and removal of the classification assembly from the second bracket. By designing the discharging module, the discharging module is able to effectively store the fully charged batteries. In this way, the battery charging case of this design can effectively store, screen, and charge the batteries to be charged, and can also effectively store the fully charged batteries, which is functionally complete and easy to use.

### BRIEF DESCRIPTION OF DRAWINGS

In order to provide a clearer explanation of the technical solution of the embodiments of the present application, the accompanying drawings required for the description of the embodiments will be briefly introduced below. Obviously, the accompanying drawings described below are some embodiments of the present invention, and those of ordinary skill in the art can also obtain other drawings based on these ones without creative labor.

FIG. 1 is a structure diagram of a battery charging case in one embodiment of the present application;

FIG. 2 is a structure diagram of a cross-section of a battery charging case in one embodiment of the present application;

FIG. 3 is a structure diagram of a cross-section of a charging module in one embodiment of the present application;

FIG. 4 is a structure diagram of a screening assembly and a second drive assembly installed on a first bracket in one embodiment of the present application;

FIG. 5 is a structure diagram of FIG. 4 from another perspective;

FIG. 6 is an exploded structure diagram of FIG. 5;

FIG. 7 is a structure diagram of FIG. 6 from another perspective;

FIG. 8 is a structure diagram of a screening plate in the initial state in one embodiment of the present application;

FIG. 9 is a structure diagram of a screening plate in one embodiment of the present application when moving to a first screening port to align with a first through slot;

FIG. 10 is a structure diagram of a screening plate in one embodiment of the present application when moving to a first screening port to align with a second through slot;

FIG. 11 is a structure diagram of a screening plate in one embodiment of the present application when moving to a second screening port to align with a third through slot;

FIG. 12 is a structure diagram of a screening plate in one embodiment of the present application when moving to a second screening port to align with a fourth through slot;

FIG. 13 is a structure diagram of a cross-section of a charging module in another embodiment of the present application;

FIG. 14 is a structure diagram of a classification assembly installed on a second bracket in one embodiment of the present application;

FIG. 15 is a structure diagram of FIG. 14 from another perspective;

FIG. 16 is an exploded structure diagram of FIG. 14;

FIG. 17 is a structure diagram of a cross-section of a charging module in another embodiment of the present application;

FIG. 18 is a structure diagram of the charging clamping structure and the first drive assembly installed on the first bracket in one embodiment of the present application;

FIG. 19 is a structure diagram of the charging clamping structure and the first drive assembly in one embodiment of the present application;

FIG. 20 is a structure diagram of FIG. 19 from another perspective;

FIG. 21 is an exploded structure diagram of the clamping assembly, charging assembly, and first drive assembly in one embodiment of the present application;

FIG. 22 is a schematic top plan view of FIG. 19;

FIG. 23 is a schematic bottom plan view of FIG. 19;

FIG. 24 is a structure diagram of the first drive assembly installed on the first bracket in one embodiment of the present application;

FIG. 25 is a structure diagram of a cross-section of a charging module in another embodiment of the present application;

FIG. 26 is a structure diagram of the charging module in one embodiment of the present application when the waste compartment is in an extended state;

FIG. 27 is a structure diagram of FIG. 25 from another perspective;

FIG. 28 is a structure diagram of a cross-section of a charging module in another embodiment of the present application;

FIG. 29 is a partial breakdown structure diagram of a charging module in one embodiment of the present application;

FIG. 30 is a structure diagram of a waste compartment in one embodiment of the present application when moving relative to the base to a storage state;

FIG. 31 is a structure diagram of a waste compartment in one embodiment of the present application when moving relative to the base to an extended state;

FIG. 32 is a structure diagram of FIG. 30 from another perspective;

FIG. 33 is a structure diagram of FIG. 31 from another perspective;

FIG. 34 is a structure diagram of a discharging module in one embodiment of the present application;

FIG. 35 is a breakdown structure diagram of a discharging outer compartment and a discharging inner compartment in one embodiment of the present application;

FIG. 36 is a partial breakdown structure diagram of a discharging module in one embodiment of the present application;

FIG. 37 is a structure diagram of a cross-section of a discharging module in one embodiment of the present application;

FIG. 38 is a schematic side elevational view of FIG. 37;

FIG. 39 is a structure diagram of the fully charged batteries placed inside the chamber of the discharging inner compartment in one embodiment of the present application;

FIG. 40 is a partial breakdown structure diagram of a discharging inner compartment in one embodiment of the present application;

FIG. 41 is a structure diagram of a press assembly and a toggle assembly in one embodiment of the present application;

FIG. 42 is a structure diagram of FIG. 41 from another perspective;

FIG. 43 is a breakdown structure diagram of a press assembly and a toggle assembly in one embodiment of the present application;

FIG. 44 is a structure diagram of FIG. 43 from another perspective;

FIG. 45 is a structure diagram of a feeding module in one embodiment of the present application;

FIG. 46 is a partial structure diagram of a cross-section of a battery charging case in one embodiment of the present application;

FIG. 47 is a structure diagram of a feeding outer compartment in one embodiment of the present application;

FIG. 48 is an enlarged schematic view of the structure at A in FIG. 47;

FIG. 49 is an enlarged schematic view of the structure at B in FIG. 47;

FIG. 50 is a partial breakdown structure diagram of a feeding module in one embodiment of the present application;

FIG. 51 is a structure diagram of a feeding inner compartment in one embodiment of the present application;

FIG. 52 is a structure diagram of a feeding inner compartment from another perspective in one embodiment of the present application;

FIG. 53 is a structure diagram of a cross-section of a feeding module in one embodiment of the present application;

FIG. 54 is a structure diagram of a guide structure in one embodiment of the present application.

Reference Numerals in the drawings: 1. Battery charging case; XX′, length direction; YY′, width direction; ZZ′, height direction; 10. Feeding module; 11. Feeding compartment; 111. Feeding outer compartment; 1111. Block; 112. Feeding inner compartment; 112a. Bottom surface; 112b. First surface; 112c. Second surface; 112d. Skeleton slot; 1121. Compartment; 1122. Offsetting flange; 13. Guide structure; 131. Guide roller; 131a. Hole; 132. Fastening unit; 1321. Snap pin; 14. Support structure; 141. Support plate; 20. Charging module; 21. Charging compartment; 211. Compartment body; 212. First bracket; 212a. Battery installation through slot; 212a1. First through slot; 212a2. Second through slot; 212a3. Third through slot; 212a4. Fourth through slot; 212b. First perforation; 212c. Limit hole; 213. Second bracket; 213a. Channel; 213b. First opening; 213c. Second opening; 2. Clamping assembly; 221. gripper; 221a. Second perforation; 221b. Groove; 222. Connection unit; 222a. Connection block; 222b. Limit slot; 223. Limit unit; 223a. Limit column; 23. Charging assembly; 231. Charging circuit board; 232. Charging terminal group; 232a. Charging terminal; 24. First drive assembly; 241. Drive bracket; 241a. Drive frame; 241b. Drive block; 241c. Limit protrusion; 242. First motor; 25. Screening assembly; 251. Screening plate; 251a. Screening port; 251a1. First screening port; 251a2. Second screening port; 2511. Plate body; 2512. blocking plate; 2512a. Hollow hole; 252. Transmission rack; 253. buffers; 2531. Buffer partition; 26. Second drive assembly; 261. Second motor; 262. Transmission gear; 27. Limit structure; 271. Limit flange; 272. Limit groove; 29. Classification assembly; 291. Third motor; 292. Classification member; 292a. Skeletonized area; 41. Partition assembly; 411. Partition plate; 411a. Partition port; 51. Base; 51a. Discharging port of the base; 51b. Support surface; 52. waste compartment; 52a. Feeding port of the waste compartment; 52b. Inclined surface; 52c. Guide surface; 30. Discharging module; 31. Discharging compartment; 311. Discharging outer compartment; 311a. Opening; 312. Discharging inner compartment; 312a. Discharging port of the discharging compartment or the discharging inner compartment; 3121. Side plate; 3121a. Second slot; 32. Carrier structure; 321. First carrier plate; 321a. First carrier surface; 321b. Through slot; 322. Second carrier plate; 3221. First subplate; 3221a. Second carrier surface; 3222. Second subplate; 3222a. Third carrier surface; 323. Third carrier plate; 323a. Fourth carrier surface; 324. Guide plate; 33. Discharge structure; 331. Press assembly; 3311. Press member; 3312. Resilient member; 3313. Second rotating shaft; 332. Toggle assembly; 3321. Toggle member; 3321a. Toggle plate; 3321b. Toggle flange; 3322. Connecting member; 3323. First rotating shaft.

### DESCRIPTION OF EMBODIMENTS

In order to make the purpose, technical solution, and advantages of the present application clearer and more understandable, further detailed explanations of the present application will be provided in conjunction with the accompanying drawings and embodiments. It should be understood that the specific embodiments described herein are only used to explain, rather than limit the present application.

On the one hand, as the outer shell of charging module 20, the charging compartment 21 comprises a compartment body 211 and, for example, the outer contour shape of compartment body 211 can be, but is not limited to, a rectangular prism or a cylindrical prism; the specific preparation material of the compartment body 211, can be, but is not limited to, plastic cement or one of the plastics. Designing the preparation material of compartment body 211 as plastic cement or plastics can effectively reduce the cost of the battery charging case 1.

On the other hand, as the bracket of charging module 20, the charging compartment 21 also comprises a first bracket 212; the specific preparation material of the first bracket 212 can be, but is not limited to, plastic cement or one of the plastics.

The first bracket 212 comprises a battery installation through slot 212a for accommodating batteries to be charged; “the battery installation through slot 212a” refers to an area on the first bracket 212 used to place the batteries to be charged; the batteries to be charged that flow out from the discharging port of the feeding module 10 (as described below) of the battery charging case 1 will directly fall into the battery installation through slot 212a of the first bracket 212 after entering the chamber of the compartment body 211 through the feeding port of compartment body 211.

The first bracket 212 or the second bracket 213 may be, but is not limited to, detachably fixedly connected to the compartment body 211 by at least one of screwing, snapping, or plugging; the first bracket 212 or the second bracket 213 may be, but is not limited to, non-detachably fixedly connected to the compartment body 211 by means of gluing.

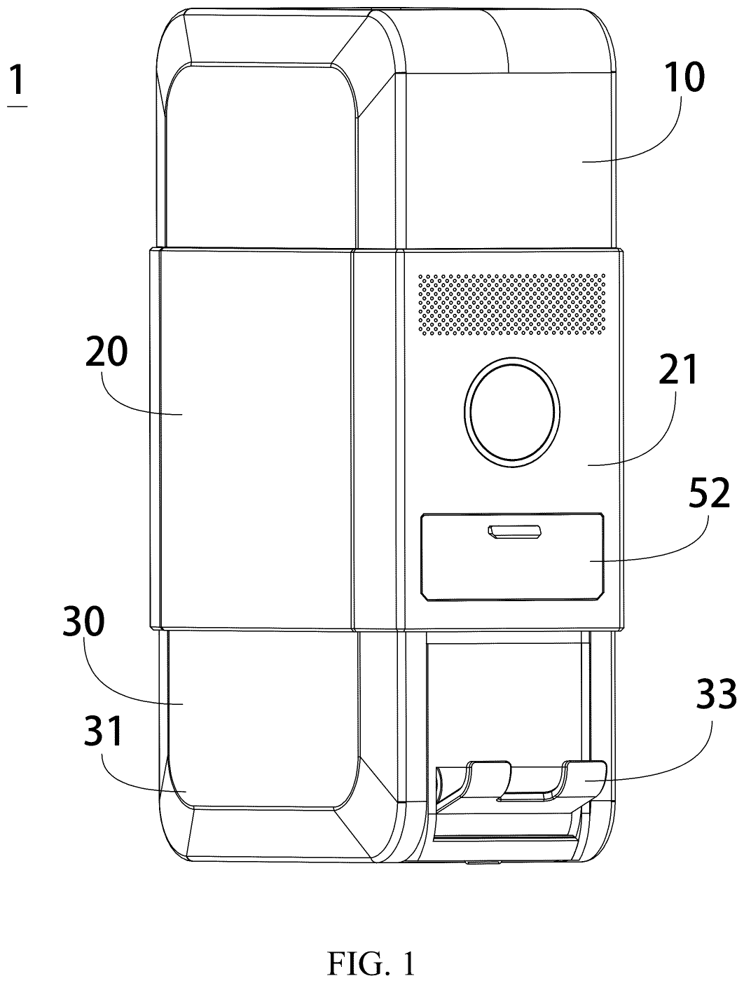

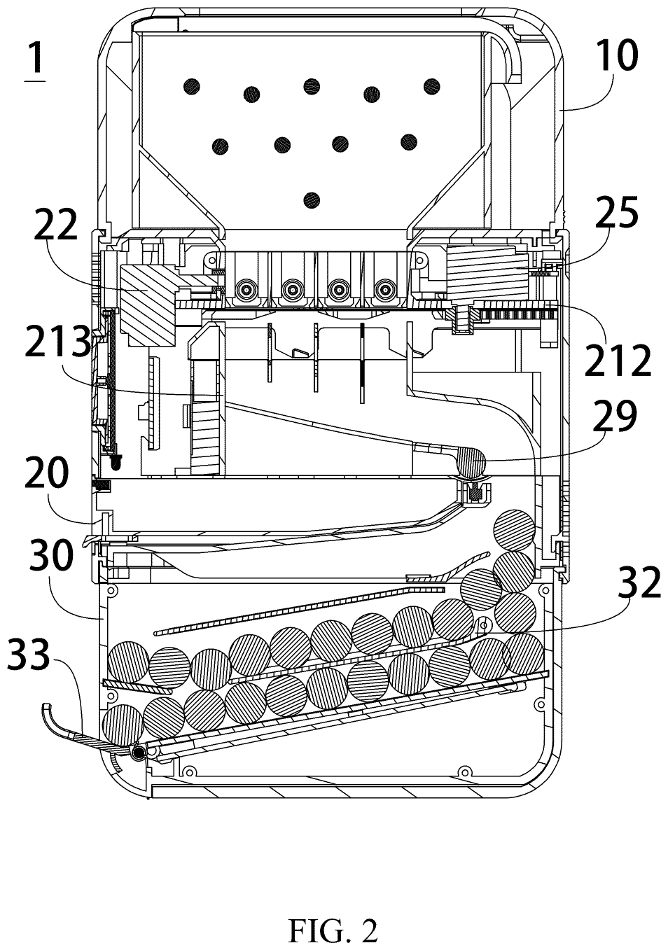

As shown in FIGS. 1-2, the screening assembly 25 is used as a structural assembly of the charging module 20 to effectively screen out the batteries to be charged that fall into the battery installation through slot 212a the ones that meet model requirements and the ones that do not meet model requirements.

Wherein the battery installation through slot 212a comprises an opening into which the batteries to be charged will flow and another opening (i.e., the discharge side of the battery installation through slot 212a) from which the batteries to be charged will flow out.

The second bracket 213 comprises a channel 213a for the flow of fully charged batteries and waste batteries; wherein the waste batteries may, but are not limited to, include batteries to be charged that meet the requirements of the model and are damaged, and batteries to be charged that do not meet the requirements of the model.

The second bracket 213 is provided further away from the feeding port of the compartment body 211 compared to the first bracket 212, i.e., the second bracket 213 is located below the first bracket 212, so that the batteries to be charged and the waste batteries flowing out of the battery mounting channel 213a can all fall into the channel 213a of the second bracket 213. The second bracket 213 may be, but is not limited to, removably connected to the first bracket 212 by at least one of screwing, snap-fitting, or plug-fitting.

A classification assembly 29 is mounted to the second bracket 213 and is located on the discharge side of the second bracket 213, and the fully charged batteries and the waste batteries flowing out of the channel 213a of the second bracket 213 may be moved to the corresponding area (the discharge port of the base 51 or the waste compartment 52) after being sorted by the classification assembly 29.

The discharge module 30 is used to store the fully charged batteries. The feeding module 30 is connected to the discharge port of the base 51.

Furthermore, the second bracket 213 is detachably connected to the first bracket 212 by means of locking screws, which is simple to operate and easy to realize.

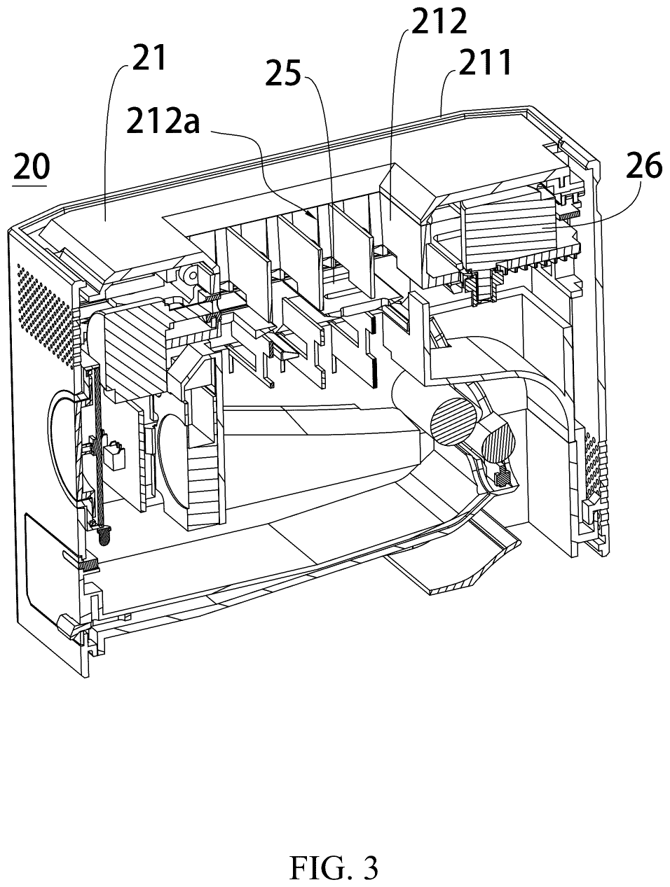

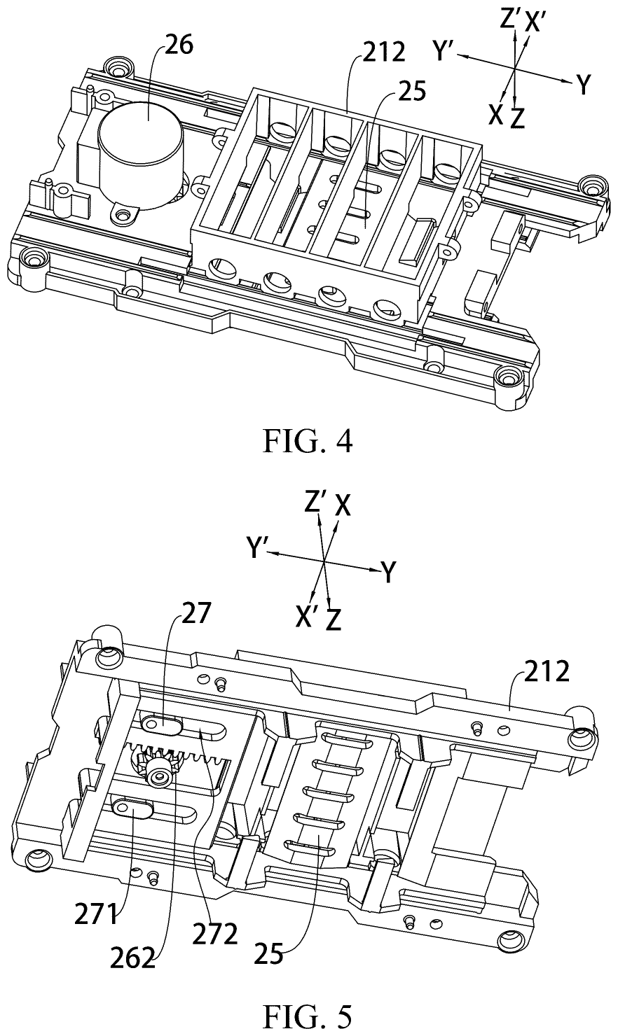

Furthermore, as shown in FIGS. 3-5, the screening assembly 25 has a screening port 251a for battery flow-through; the charging module 20 further includes a second drive assembly 26, the second drive assembly 26 is installed on the first bracket 212 and is drivingly connected to the screening assembly 25; the second drive assembly 26 is configured to drive the screening assembly 25 along the width direction YY of the battery charging case 1′; when the screening assembly 25 moves until the screening port 251a is aligned with the battery installation through slot 212a, the battery that meets the model requirements can pass through the screening port 251a; when the screening assembly 25 moves until the screening port 251a is offset from the battery installation through slot 212a, the battery to be charged that does not meet the model requirements can pass through the screening port 251a.

Wherein, the shape and size of the screening port 251a is compatible with the battery to be charged that meets the model requirements; the battery to be charged that meets the model requirements is larger in size than the battery to be charged that does not meet the model requirements.

The second drive assembly 26 transfers the generated driving force to the screening assembly 25 to allow the screening assembly 25 to move along the width direction YY′ of the battery charging case 1.

When the second drive assembly 26 drives the screening assembly 25 to move along the width direction YY′ of the battery charging case 1 until the screening port 251a is aligned with the battery installation through slot 212a, then the screening assembly 25 will not cause obstruction to the discharge side of the battery installation through slot 212a, the battery installation through slot 212a is completely connected with the screening port 251a, and the battery that meets the model requirements inside the battery installation through slot 212a can be moved under its own gravity.

When the second drive assembly 26 drives the screening assembly 25 to move along the width direction YY′ of the battery charging case 1, and when the screening assembly 25 moves to the screening port 251a to be offset from the battery installation through slot 212a, the screening assembly 25 will cause incomplete obstruction to the discharging side of the battery installation through slot 212a, the battery installation through slot 212a and the screening port 251a are not fully connected, and the batteries to be charged in the battery installation through slot 212a that does not meet the model requirements can, under their own gravity, pass through the screening port 251a in the small gap formed by the incompletely connected battery installation through slot 212a and the screening port 251a. Due to the obstruction of screening assembly 25, the batteries in the battery installation through slot 212a that meet the model requirements, under their own gravity, cannot pass through the screening port 251a through the small gap formed by the incompletely connected battery installation through slot 212a and the screening port 251a, such that the batteries to be charged that do not meet the model requirements can be effectively screened. When the screening assembly 25 moves to the screening port 251a to align with the battery installation through slot 212a, the screening assembly 25 will not obstruct the discharging side of the battery installation through slot 212a which is fully connected to the screening port 251a, and the batteries in the battery installation through slot 212a that meet the model requirements can pass through the screening port 251a under their own gravity. In this way, effective screening of batteries to be charged that do not meet the requirements of the model can be realized.

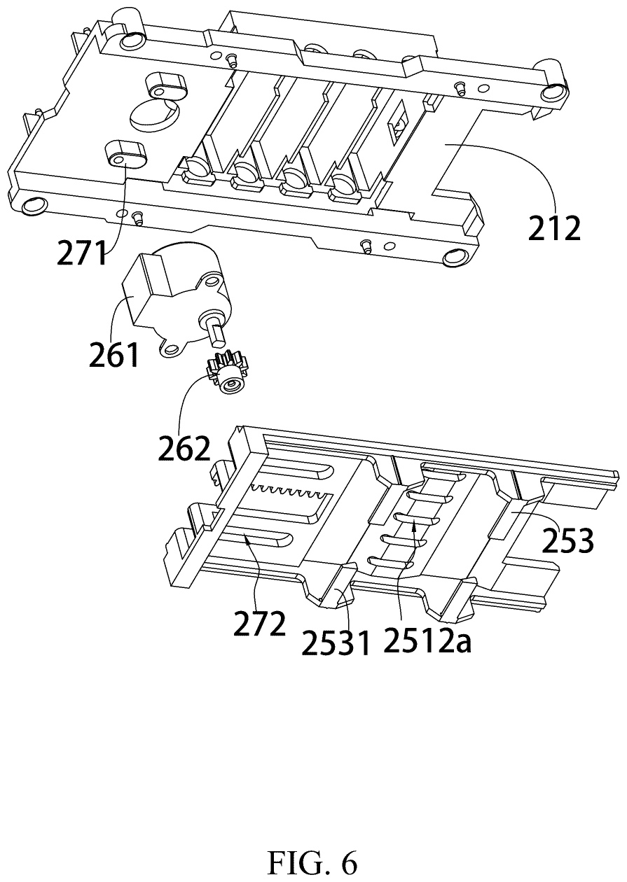

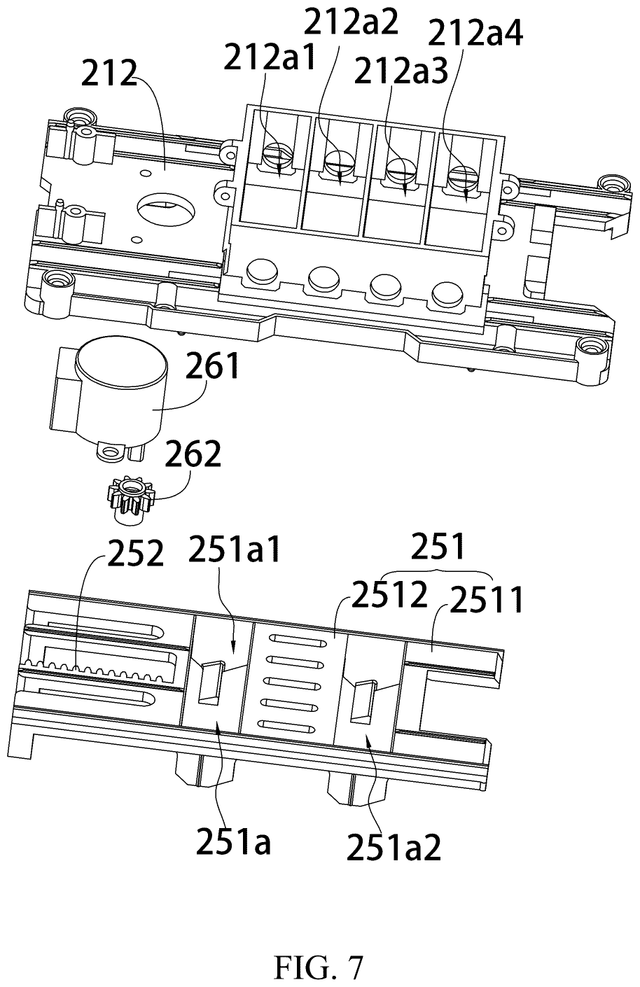

Furthermore, as shown in FIGS. 6-7, the screening assembly 25 comprises a screening plate 251 and a transmission rack 252; the screening plate 251 extends along the width direction YY′ of the battery charging case 1 and is slide connected to the first bracket 212; the transmission rack 252 extends along the width direction YY′ of the battery charging case 1 and is fixedly connected to the screening plate 251. The second drive assembly 26 is connected to the transmission rack 252 and is configured to drive the screening plate 252 to move along the width direction YY′ of the battery charging case 1 through the transmission rack 252.

The screening plate 251 is used to block the battery installation through slot 212a; the specific preparation material for screening plate 251 can be, but is not limited to, plastics or plastic cement, etc.

Specifically, the transmission rack 252 is integrally formed with the screening plate 251, and the transmission rack 252 can be integrated with the screening plate 251 through, but not limited to, injection molding or 3D printing, thus effectively reducing the processing difficulty between the transmission rack 252 and the screening plate 251. Alternatively, the transmission rack 252 and the screening plate 251 are of a split structure, and the two are fixedly connected by means of locking screws.

Furthermore, the screening assembly 25 further comprises a buffer 253, and the buffer 253 is connected to the side of the screening plate 25 facing away from the battery installation through slot 212a and is disposed corresponding to the screening port 251a.

The batteries that meet the model requirements and the batteries that do not meet the model requirements, when falling from the screening port 251a, will fall onto the buffer 253, and the buffer 253 is used to provide buffering force to reduce the possibility of other assembly and the batteries being damaged by the impact force from the batteries that meet the model requirements and the batteries that do not meet the model requirements falling from the screening port 251a.

In the first embodiment, the buffer 253 comprises a buffer partition that is arranged in a cantilever shape and integrally formed with the screening plate 251. The buffer partition 2531 can be integrated with the screening plate 251 through, but not limited to, injection molding or 3D printing. The buffer 253 is designed as a cantilevered buffer partition 2531, with one end of the buffer partition 2531 suspended away from the screening plate 251, so that the batteries to be charged fall from the screening port 251a onto the buffer partition 2531, driving the buffer partition 2531 to constantly swing.

In the second embodiment, the buffer 253 includes a partition (not shown in the drawing) and a buffer pad (not shown in the drawing), and the partition comprises a semi-bracket structure, and both ends of the partition are fixedly connected to the screening plate 251, and the buffer pad is disposed on the side of the partition facing the screening port 251a; the preparation material of buffer pad can be, but is not limited to, elastic rubber. The partition is used to provide support for the buffer pad, the batteries fall from the screening port 251a onto the buffer pad, causing the buffer pad to deform, such that a portion of energy of the falling batteries during the process of falling can be consumed, and the design serves as a buffer to reduce the possibility of other assembly and the batteries being damaged by the impact force from such falling batteries.

Furthermore, the charging module 20 further comprises a limit structure 27, and the limit structure 27 is disposed on the first bracket 212 and the screening plate 251 and is configured to control the movement of the screening plate 251 along the width direction YY′ of the battery charging case under the action of the second drive assembly 26 within a preset range. The specific value of the “preset range” is not limited here, as long as it is larger than or equal to the minimum stroke that the screening plate 251 can move along the width direction YY′ of the battery charging case to the screening port 251a to align with and to be offset from the battery installation through slot 212a.

Specifically, the limit structure 27 comprises a limit flange 271, and a limit groove 272 extending along the width direction YY′ of the battery charging case 1, the limit flange 271 is disposed on one of the first bracket 212 and the screening plate 251, the limit groove 272 is disposed on the other of the first bracket 212 and the screening plate 251, and the limit flange 271 is embedded in the limit groove 272. The limit flange 271 can be integrated with one of the first bracket 212 and the screening plate 251 through, but not limited to, injection molding or 3D printing. The limit structure 27 is designed as a limit flange 271 and a limit groove 272, the second drive assembly 26 drives the screening plate 251 to move along the width direction YY′ of the battery charging case 1, and the limit flange 271 is disposed against the groove wall of the limit groove 272 in the width direction YY′ of the battery charging case 1, in order to restrict the screening plate 251 from continuing to move along the width direction YY′ of the battery charging case 1, such that the movement stroke of the screening plate 251 in the width direction YY′ of battery charging case 1 falls within the preset range.

Furthermore, the second drive assembly 26 comprises a second motor 261 installed on the first bracket 212 and a transmission gear 262 that is fixedly connected to the drive shaft of the second motor 261 and meshes with the transmission rack 252.

When the second motor 261 is detachably connected to the first bracket 212, the second motor 261 can be fixedly connected to the first bracket 212 through, but not limited to, at least one of screw connection, snap-in connection, or plug-in connection and, for example, when the second motor 261 is not detachably connected to the first bracket 212, the second motor 261 can be fixedly connected to the first bracket 212 through, but not limited to, adhesive bonding.

The second motor 261 drives the transmission gear 262 to rotate, and the rotating transmission gear 262 drives the transmission rack 252 that meshes with it to move along the width direction YY′ of the battery charging case 1.

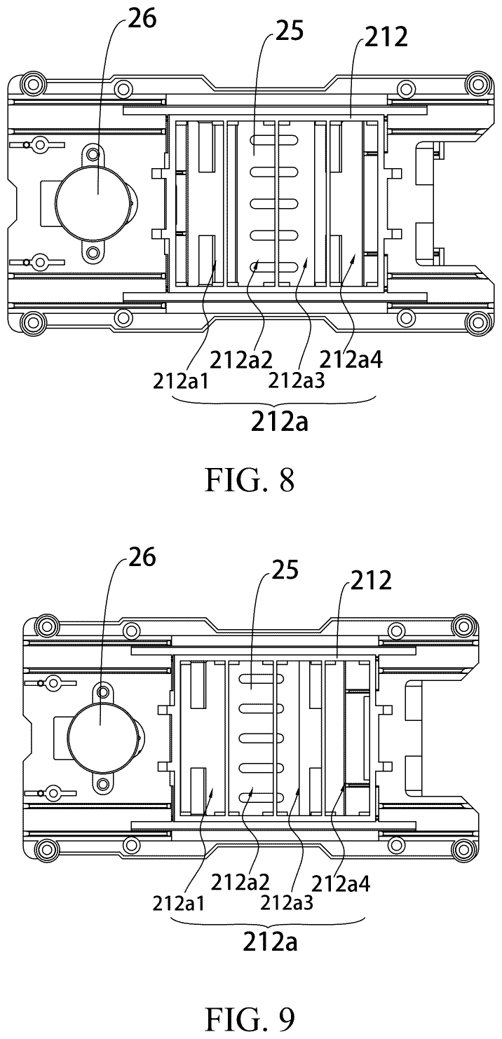

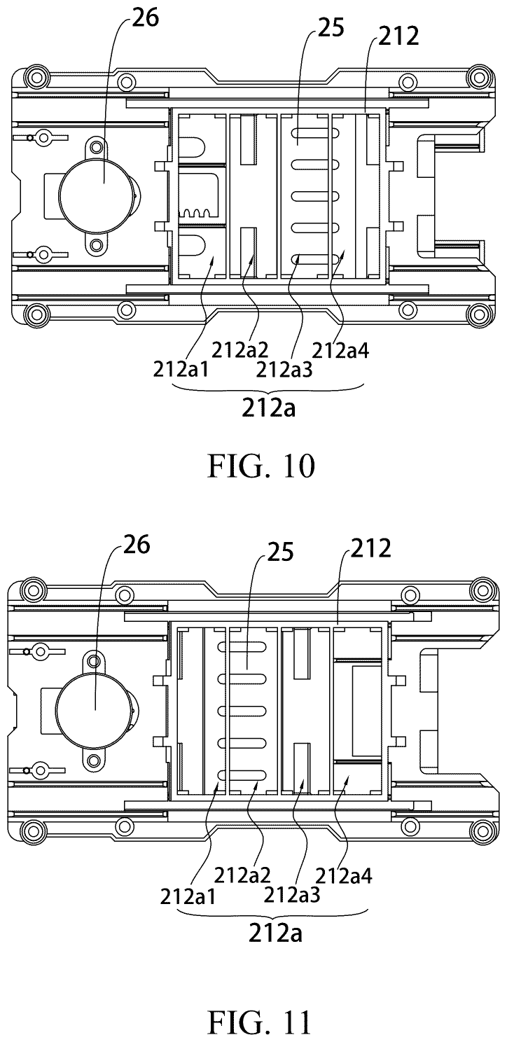

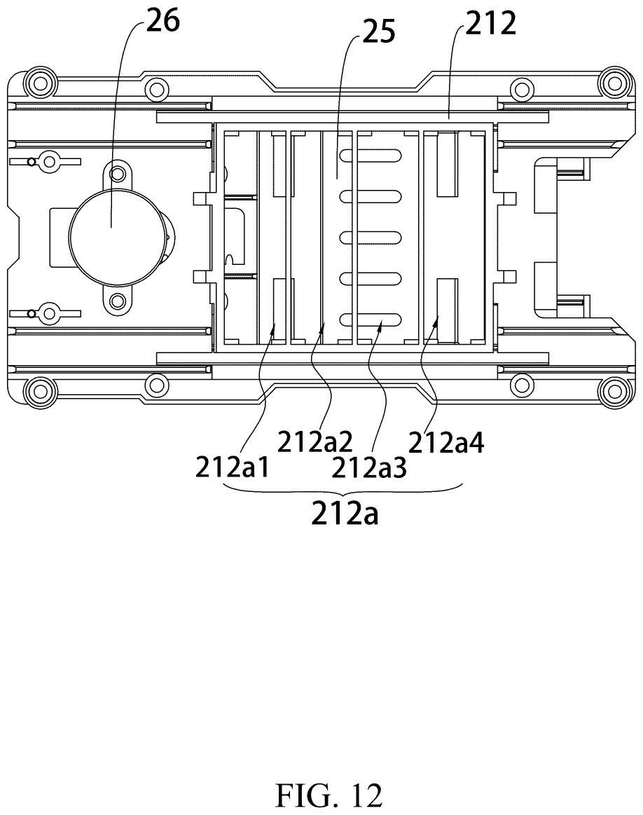

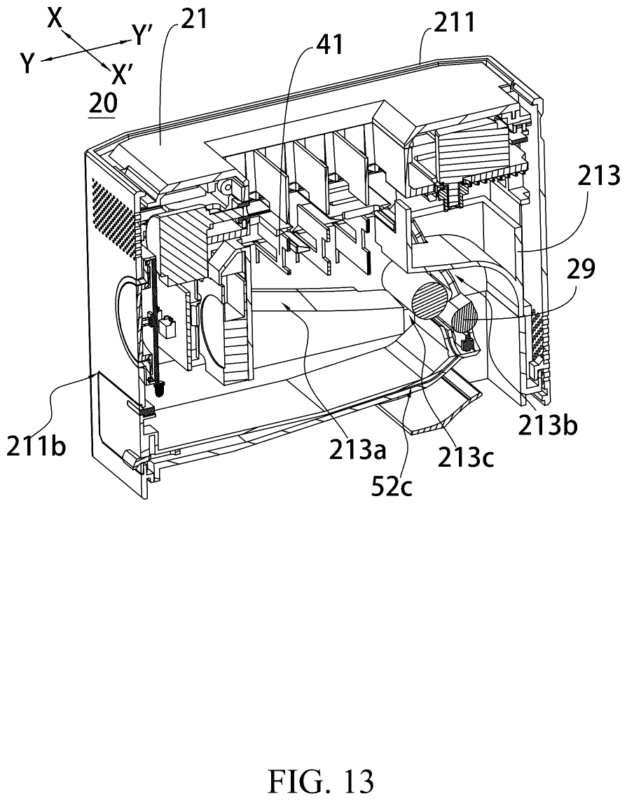

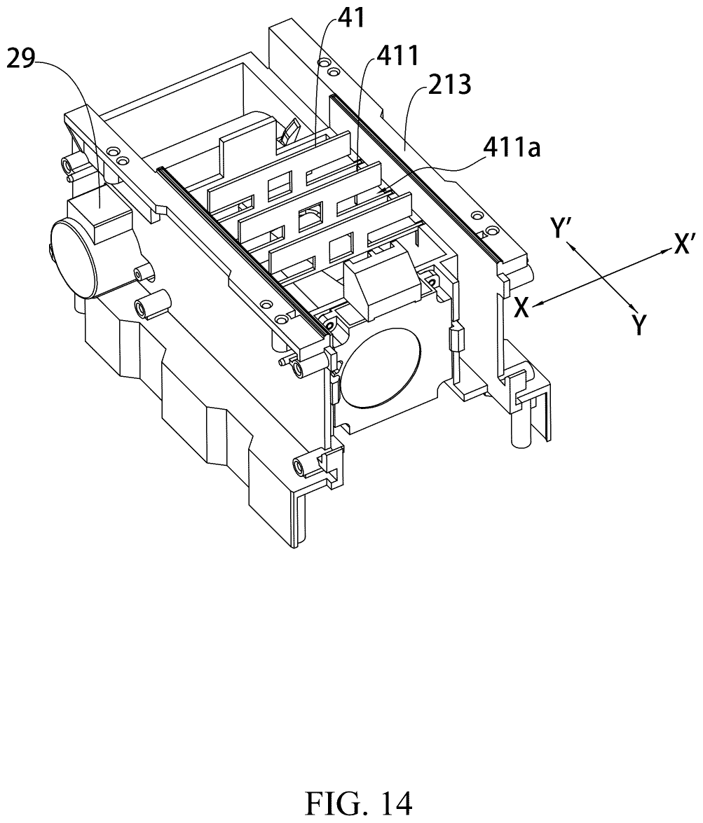

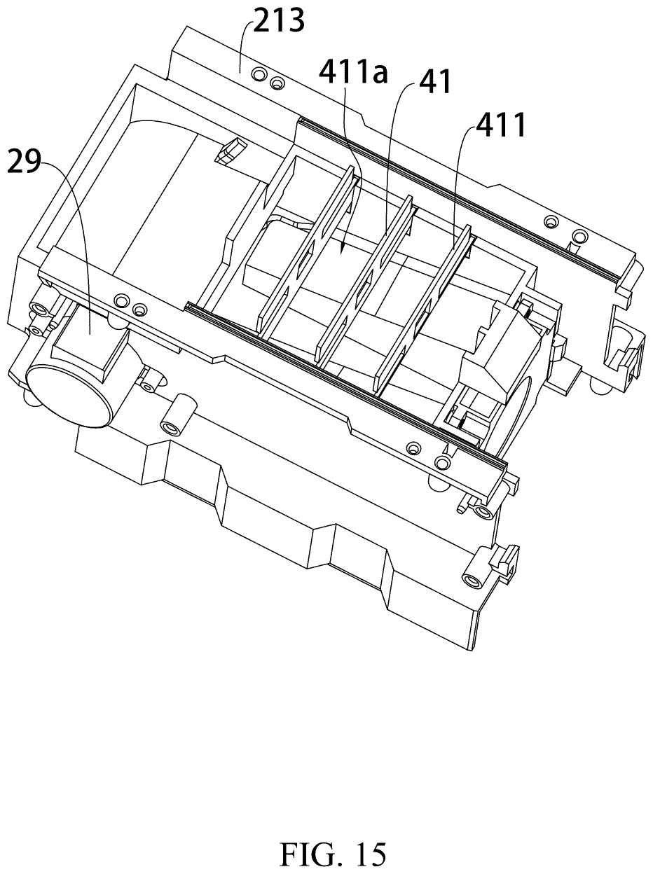

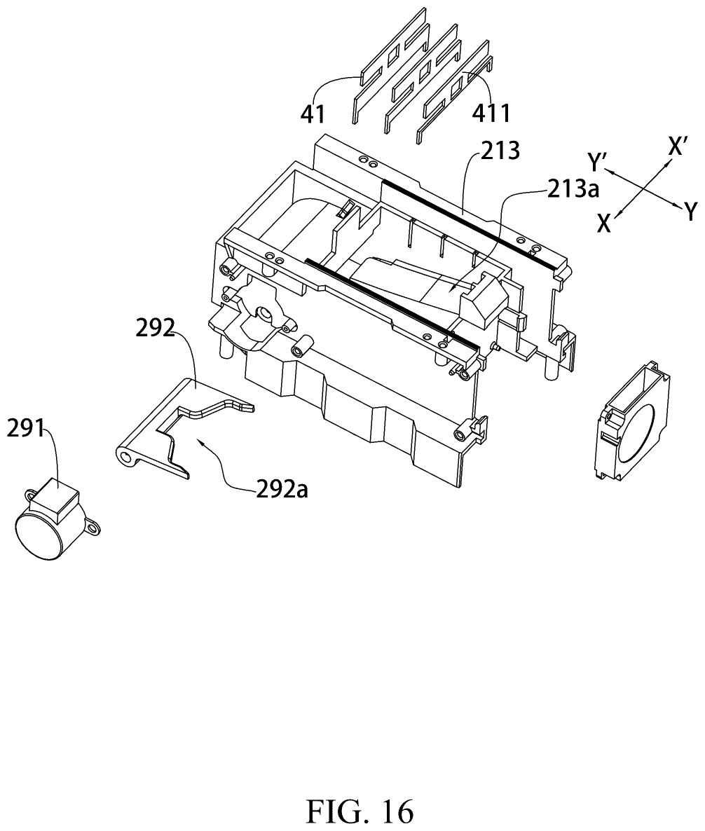

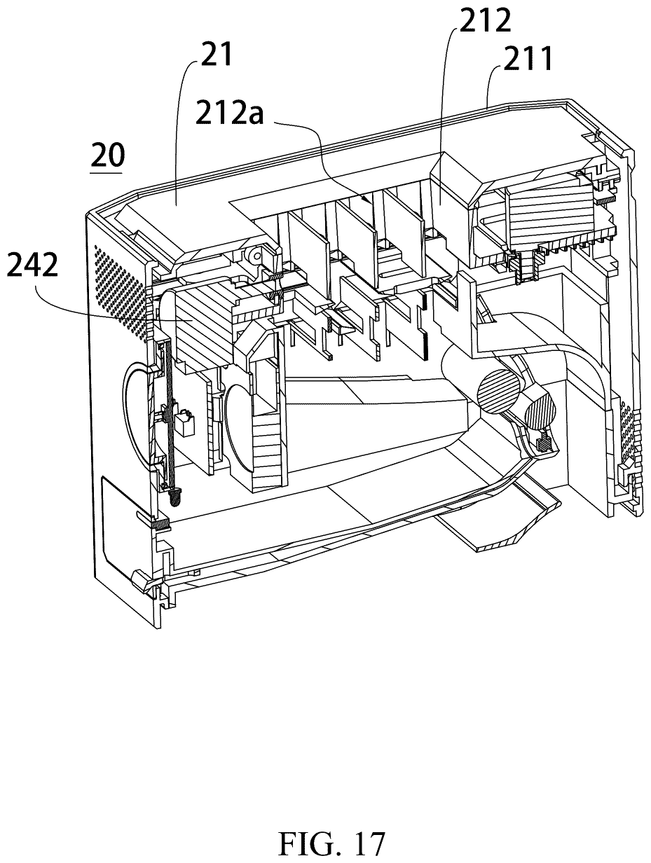

As shown in FIGS. 8-12, understandably, the number of battery installation through slot 212a on the first bracket 212 can be one or multiple (two or more).

There are multiple battery installation through slots 212a on the first bracket 212, and the multiple battery installation through slots include a first through slot 212a1, a second through slot 212a2, a third through slot 212a3, and a fourth through slot 212a4 arranged along the width direction of the battery charging case 1; the screening plate 251 comprises a plate body 2511 and a blocking plate 2512, wherein the plate body 2511 extends along the width direction YY′ of the battery charging case 1 and is slidably connected to the first bracket 212, while the plate body 2511 comprises a through hole that penetrates the plate body 2511 in a height direction ZZ′ of the battery charging case 1, and the blocking plate 2512 is located inside the through hole and is connected to the plate body 2511 to divide the through hole into two above screening ports 251a (two screening ports 251a include a first screening port 251a1 and a second screening port 251a2). Along the width direction YY′ of the battery charging case 1, the width dimension of blocking plate 2512 is larger than that of the first through slot 212a1, the second through slot 212a1, the third through slot 212a1, and the fourth through slot 212a1; the second motor 261 is configured to drive the screening plate 251 to perform reciprocating motion along the width direction YY′ of the battery charging case, such that the charging module 20 effectively screens multiple batteries to be charged simultaneously, improving the screening efficiency.

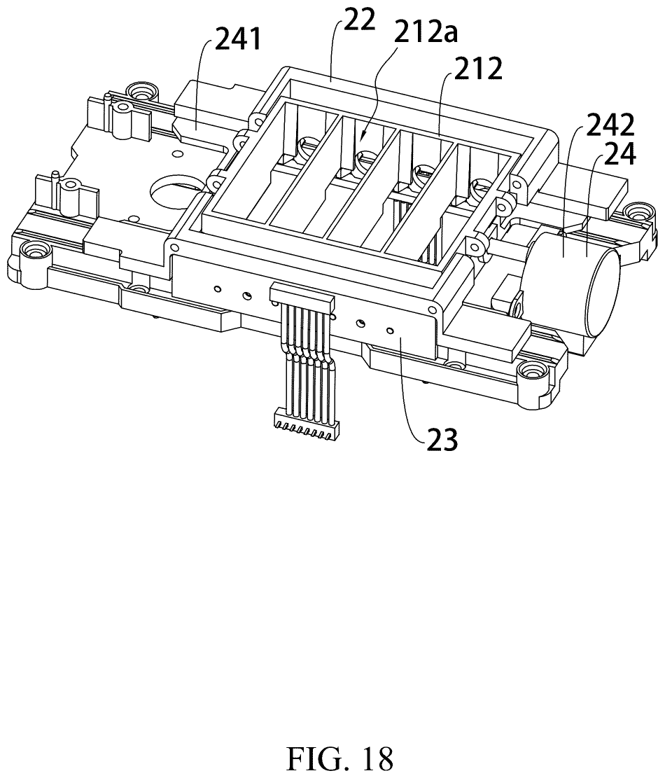

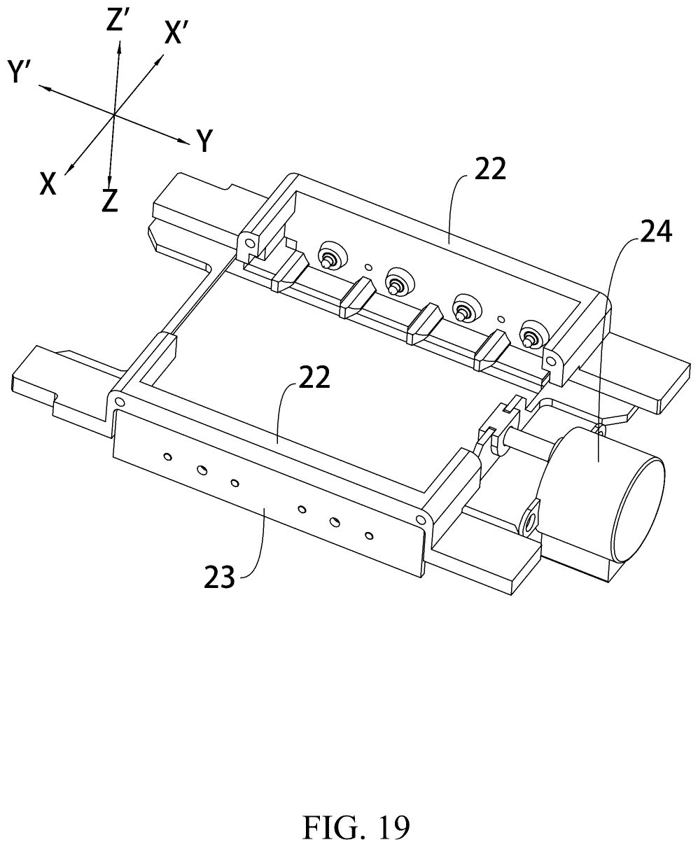

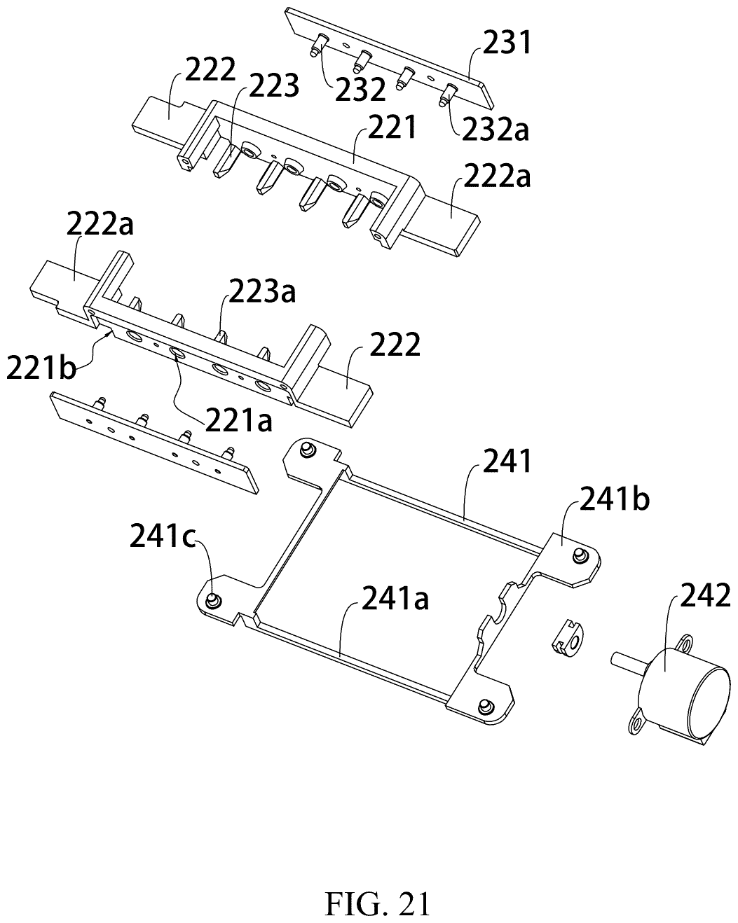

Furthermore, as shown in FIG. 18-21, the charging clamping structure comprises a clamping assembly 22 and a charging assembly 23; the clamping assembly 22 is installed on the first bracket 212 corresponding to battery installation through slot 212a, and is drivingly connected to the first drive assembly 24; the charging assembly 23 is installed on the clamping assembly 22 which facilitates effective contact between the charging terminal of the charging assembly 23 and the electrodes of the battery to be charged while the clamping assembly 22 clamps and fixes the battery to be charged, and makes the spatial arrangement of the charging assembly 23 and the clamping assembly 22 more compact, so that the overall volume of the charging module 20 can be effectively reduced, and the charging assembly 23 has a charging end for electrically connecting with the electrodes of the battery to be charged. electrode of the battery to be charged, the charging assembly 23 having a charging terminal for electrically connecting with the electrode of the battery to be charged.

The clamping assembly 22 is used, on the one hand, to clamp the batteries to be charged to maintain relative fixation of the position between the batteries to be charged and the first bracket 212 and on the other hand, to release the fully charged battery, so as to make relative position change between the fully charged battery and the first bracket 212; the specific structure of clamping assembly will be introduced below. It should be noted that clamping assembly 22 can be clamped and fixed from one side or from both sides of the batteries to be charged. Charging assembly 23 is used to electrically connect with the electrodes of the batteries to be charged, in order to charge such batteries.

The first drive assembly 24 moves along the width direction YY′ of battery charging case 1 to drive the clamping assembly 22 to move along the length direction XX′ of battery charging case 1, so that the clamping assembly 22 clamps the batteries to be charged, while electrical conductivity is maintained between the clamping assembly 22 and the electrodes of the batteries to be charged to charge the batteries to be charged. When the batteries to be charged are fully charged, the first drive assembly 24 also moves along the width direction YY′ of battery charging case 1 to drive the clamping assembly 22 to move along the length direction XX′ of battery charging case 1, such that the clamping assembly 22 maintains electrical disconnection between the charging terminal of charging assembly 23 and the electrodes of fully charged batteries, while releasing the fully charged batteries.

Furthermore, the clamping assembly 22 comprises two grippers 221 and two connection units 222; two grippers 221 are installed on the first bracket 212 corresponding to the battery installation through slot 212a, and the charging assembly 23 is installed on the two grippers 221; two connection units 222 are connected one-to-one with two grippers 221, and the two grippers 221 are respectively drivingly connected to the first drive assembly 24 through the corresponding connection units 222; the first drive assembly 24 is configured to move along the width direction YY′ of battery charging case 1, and through the connection unit 222, drives two grippers 221 to approach each other along the length direction XX′ of battery charging case 1, so that the two grippers 221 clamp the batteries to be charged from both ends and make the charging terminal of charging assembly 23 contact the electrodes of the batteries to be charged.

The cross-section of the grippers 221 perpendicular to the height direction ZZ′ of battery charging case 1 can be shaped like an “I” or a “half frame”.

When the batteries to be charged are fully charged, the first drive assembly 24 moves along the width direction YY′ of battery charging case 1 and, through the connection unit 222, drives the two grippers 221 to move away from each other along the length direction XX′ of battery charging case 1, then the two grippers 221 move along the length direction XX′ of battery charging case 1 to the initial position to release the fully charged batteries, while providing electrical disconnection between the charging terminal of charging assembly 23 and the electrodes of fully charged batteries.

Furthermore, the charging assembly 23 comprises two charging circuit boards 231 that are one-to-one connected to two corresponding grippers 221, two charging terminal groups 232 that serve as charging terminals and are one-to-one electrically connected to the two charging circuit boards 231; one of the charging terminal groups 232 is used to make contact with the positive electrodes of the batteries to be charged, and the other charging terminal group 232 is used to make contact with the negative electrodes of the batteries to be charged.

The charging circuit board 231 can be a rigid circuit board, a flexible circuit board, or a combination of flexible and rigid circuit boards; It should be noted that when the charging circuit board 231 is a flexible circuit board, the charging assembly 23 may also include a reinforcing plate that is disposed on one side of the flexible circuit board to provide support for the flexible circuit board. Each charging circuit board 231 is installed on the corresponding gripper 221a and, for example, when the charging circuit board 231 is detachably connected to the gripper 221, the charging circuit board 231 can be fixedly connected to the gripper 221 through, but not limited to, at least one of screw connection, snap-in connection, or plug-in connection and, for example, when the charging circuit board 231 is not detachably connected to the gripper 221, the charging circuit board 231 can be fixedly connected to the gripper 221 through, but not limited to, adhesive bonding.

Wherein the electrical connection is maintained between the charging terminal group 232 on one charging circuit board 231 and the positive electrodes of the batteries to be charged, as well as between the charging terminal group 232 on another charging circuit board 231 and the negative electrodes of the batteries to be charged.

Furthermore, there are multiple battery installation through slots 212a, and the multiple battery installation through slots 212a are arranged along the width direction YY′ of battery charging case 1; the two side plates of the first bracket 212, which are arranged opposite each other along the length direction XX′ of battery charging case 1, are provided with multiple first perforations 212b that correspond one-to-one to the multiple battery installation through slots 212a; the two grippers 221 are located on both sides of the first bracket 212 along the length direction XX′ of battery charging case 1; each of the charging terminal groups 232 includes multiple charging terminals 232a that are equal in number to the multiple battery installation through slots 212a and are electrically connected to the corresponding charging circuit boards 231, and the multiple charging terminals 232a in the same charging terminal group 232 are arranged in one-to-one correspondence with the multiple first perforations 212b.

Each battery installation channel is embedded with a battery to be charged, the first drive assembly 24 moves along the width direction YY′ of battery charging case 1 and, through the connecting unit 222, drives the two grippers 221 to approach each other along the length direction XX′ of battery charging case 1, then the two grippers 221 move along the length direction XX′ of battery charging case 1 to clamp and fix the multiple batteries to be charged from both ends of such batteries, and multiple charging terminals 232 in the charging terminal group 232 on one of the charging circuit boards 231 run through the corresponding first perforation 212b and keep contact with the positive electrode of the batteries to be charged, and multiple charging terminals 232a in the charging terminal group 232 on the other charging circuit board 231 run through corresponding first holes 212b and keep contact with the negative electrode of the batteries to be charged, such that multiple batteries to be charged in the installation through slots 212a can be charged at once, effectively improving the charging efficiency of the charging module 20.

Furthermore, each gripper 221 is provided with multiple second perforations 221a equal in number to the multiple battery installation through slots 212a; the two charging circuit boards 231 are both located on the side of the corresponding gripper 221 facing away from the first bracket 212, and the multiple charging terminals 232a of charging terminal group 232 on the same charging circuit board 231 correspond one-to-one to the multiple second perforations 221a on the corresponding gripper 221. The side of the gripper 221 facing away from the first bracket 212 is designed with a groove 221b, and the charging circuit board 231 is embedded in the groove 221b. The charging circuit board 231 designed on the side of the gripper 221 away from the first bracket 212 is separated from the batteries to be charged, thus effectively reducing the possibility of charging circuit board 231 overheat caused by the heat emitted during battery charging that is directly transmitted to the charging circuit board 231, while also reducing the possibility of battery overheat caused by the heat emitted by charging circuit board 231 during operation that is directly transmitted to the batteries. A second perforation 221a is designed on the gripper 221, multiple charging terminals 232a in the charging terminal group 232 on the charging circuit board 231 can pass through the second perforation 221a to expose the side of the gripper 221 facing the first bracket 212, such that effective contact can be maintained between the multiple charging terminals 232a in the charging terminal group 232 and the electrodes of multiple batteries to be charged, thereby effectively charging the multiple batteries to be charged.

Furthermore, the drive assembly comprises a drive bracket 241 and a first motor 242; Drive bracket 241 is drivingly connected to two connection units 222; the first motor 242 is installed on the first bracket 212, and the drive shaft of the first motor 242 is connected to the drive bracket 241; the first motor 242 is configured to drive the drive bracket 241 to move along the width direction YY′ of battery charging case 1 and to drive the two connection units 222 to move, thereby driving the two grippers 221 to approach each other along the length direction XX′ of battery charging case 1.

The first motor 242 is a stepper motor, and drives the drive bracket 241 to perform linear reciprocating motion in the first direction. The specific model of the first motor 242 is not limited here, and designers can make reasonable choices according to actual needs. The specific connection between the first motor 242 and the first bracket 212/drive bracket 241 can be as follows and, for example, when the first motor 242 is detachably connected to the first bracket 212/drive bracket 241, the first motor 242 can be fixedly connected to the first bracket 212/drive bracket 241 through, but not limited to, screw connection, snap-in connection, or plug-in connection and, for example, when the first motor 242 is not detachably connected to the first bracket 212/drive bracket 241, the first motor 212 can be fixedly connected to the first bracket 212/drive bracket 241 through, but not limited to, adhesive bonding.

When the batteries to be charged are fully charged, the first motor 242 drives the drive bracket 241 connected to the drive shaft to make linear motion along the width direction YY′ of battery charging case 1, and the drive bracket 241 moves along the width direction YY′ of battery charging case 1 and, through the connection unit 222, drives the two grippers 221 to be away from each other along the length direction XX′ of battery charging case 1, then the two grippers 221 move along the length direction XX′ of battery charging case 1 to the initial position to release the fully charged batteries, while maintaining electrical disconnection between the charging terminal of charging assembly 23 and the electrodes of the fully charged batteries.

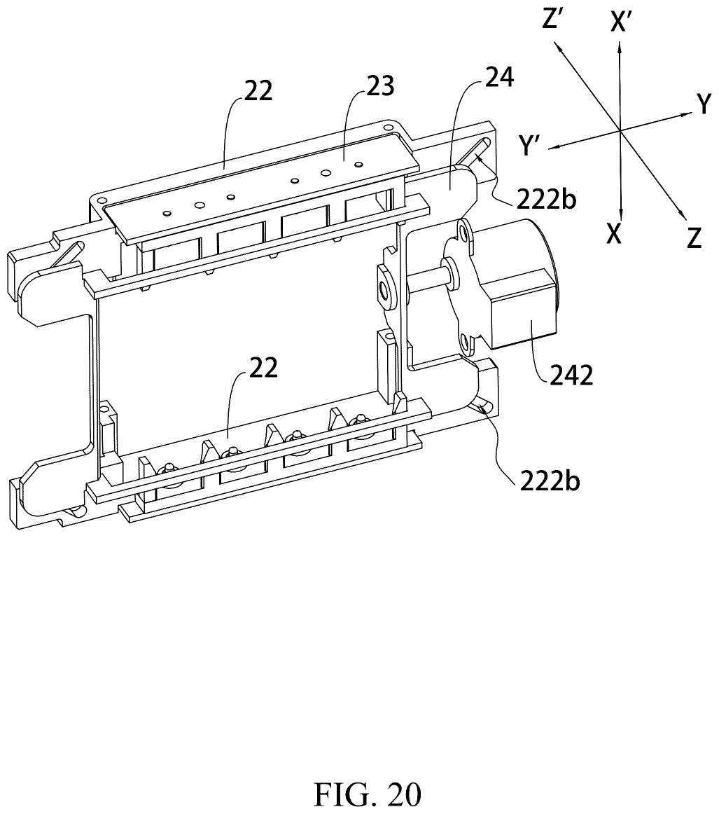

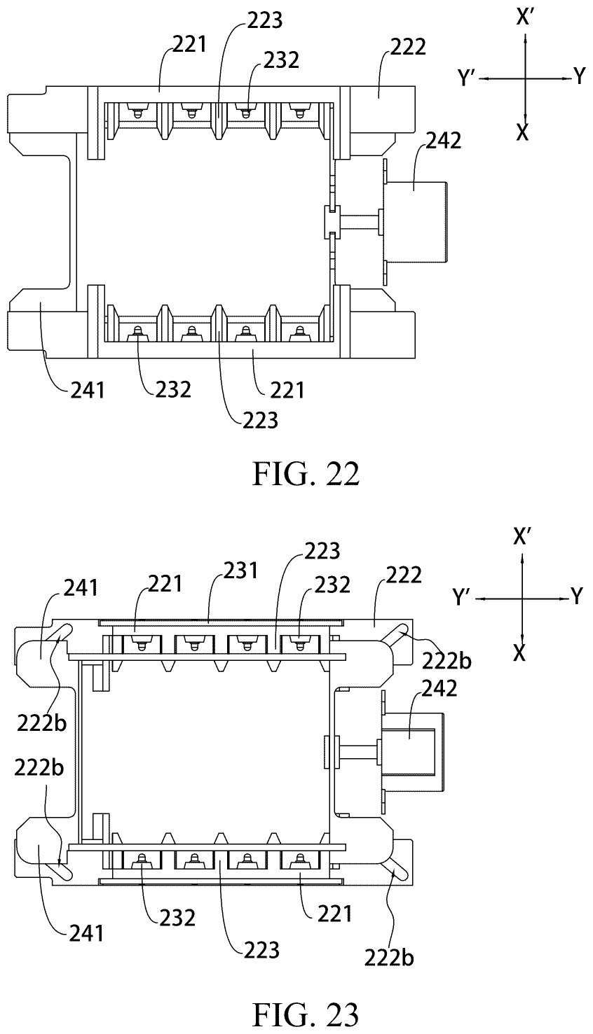

Furthermore, as shown in FIGS. 20-23, each of the connection units 222 comprises two connection blocks 222a, and the two connection blocks 222a of the same connection unit 222 are distributed on both sides of the gripper 221 along the width direction YY′ of battery charging case 1 and fixedly connected to the gripper 221, and the bottom surface of each connection block 222a is provided with a limited groove 222b. The drive bracket 241 comprises a drive frame 241a and four drive blocks 241b, and the drive frame 241a is arranged around the periphery of battery installation through slot 212a, and the four drive blocks 241b are located at the four corners of drive frame 241a and fixedly connected to the drive frame 241a, and the top surface of each drive block 241b is provided with a limit protrusion 241c; the drive shaft of the first motor 242 is connected to the drive frame 241a, and the limit protrusion 241c extends into the limit groove 222b and contacts the groove wall of limit groove 222b.

When the connection block 222a is detachably connected to the gripper 221, the connection block 222a can be fixedly connected to the gripper 221 through, but not limited to, screw connection, snap-in connection, or plug-in connection and, for example, when the connection block 222a is not detachably connected to the gripper 221, the first motor 212 can be fixedly connected to the gripper 221 through, but not limited to, adhesive bonding. The specific connection between the drive block 241b and the drive frame 241a can be as follows and, for example, when the drive block 241b is detachably connected to the drive frame 241a, the drive block 241b can be fixedly connected to the drive frame 241a through, but not limited to, screw connection, snap-in connection, or plug-in connection and, for example, when the drive block 241b is not detachably connected to the drive frame 241a, the drive block 241b can be fixedly connected to the drive frame 241a through, but not limited to, adhesive bonding. The limit groove 222b is a rectangular groove 221b, and the extension direction of limit groove 222b comprises a first assembly along the length direction XX′ of battery charging case 1 and a second assembly along the width direction YY′ of battery charging case 1. The limit protrusion 241c can be integrated with the drive block 241b through, but is not limited to, injection molding or 3D printing.

The transmission connection between connection block 222a and drive block 241b is realized through the cooperation of limit groove 222b and the limit protrusion 241c, so that when the first motor 242 drives the drive bracket 241 to perform linear motion along the width direction YY′ of battery charging case 1, and under the mutual restriction of groove wall surface of limit groove 222b and the limit protrusion 241c, the two grippers 221 can, under the driving of drive bracket 241, only perform linear motion along the length direction XX′ of battery charging case 1 and clamp and fix the batteries to be charged from both ends of such batteries.

The drive frame 241a can be integrated with four drive blocks 241b through, but not limited to, injection molding or 3D printing, effectively reducing the processing difficulty.

The gripper 221 can be integrally formed with four connection blocks 222a through, but not limited to, injection molding or 3D printing.

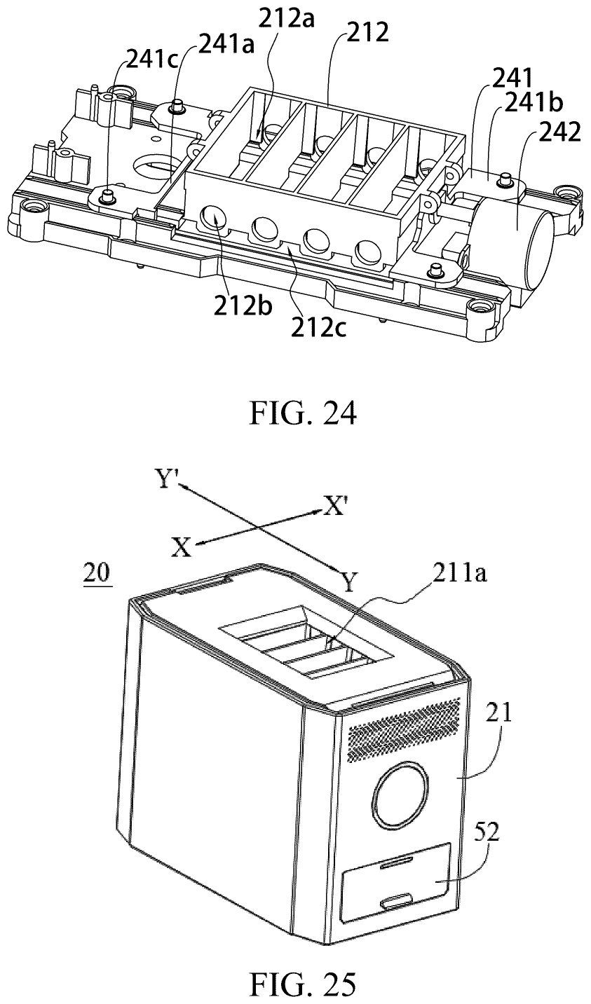

Furthermore, as shown in FIGS. 18, 21, and 24, the two side plates of the first bracket 212 that are arranged opposite each other along the length direction XX′ of battery charging case 1 are also provided with limit holes 212c that are connected to the battery installation through slot 212a; the clamping assembly 22 further comprises two limit units 223 that are connected one-to-one with the two grippers 221, and the limit units 223 are provided with limit holes 212c and are in contact with the hole walls of the limit holes 212c to make grippers 221 move deviated from the length direction of battery charging case 1. In this design, limit units 223 are designed on both grippers 221, and the limit units 223 run through corresponding limit holes 212c, the wall of limit holes 212c restricts the limit units 223, so that the two grippers 221 connected to the two limit units 223 can only perform linear motion along the length direction XX′ of battery charging case 1, ensuring that the two grippers 221 reliably clamps and fixes the batteries to be charged from both ends of such batteries.

Specifically, there are multiple limit holes 212c, and the multiple limit holes 212c are arranged at intervals along the width direction YY′ of battery charging case; each of the limit units comprises multiple limit columns 223a equal to the number of limit holes 212c, the multiple limit columns 223a are disposed on one side of the gripper 221 facing the first bracket 212, and the multiple limit columns 223a run one-to-one through the multiple limit holes. The limit column 223a can be integrated with the gripper 221 through, but not limited to, injection molding or 3D printing.

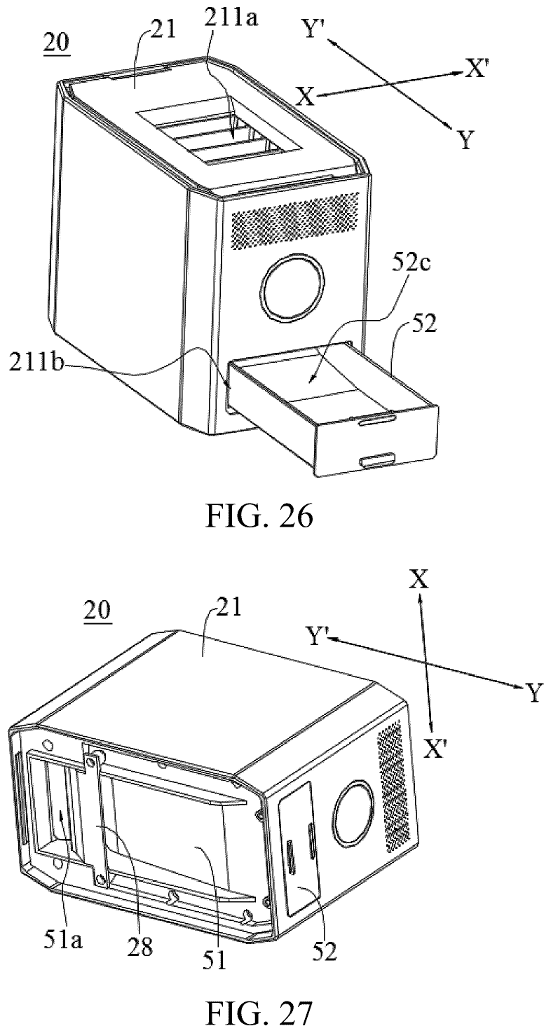

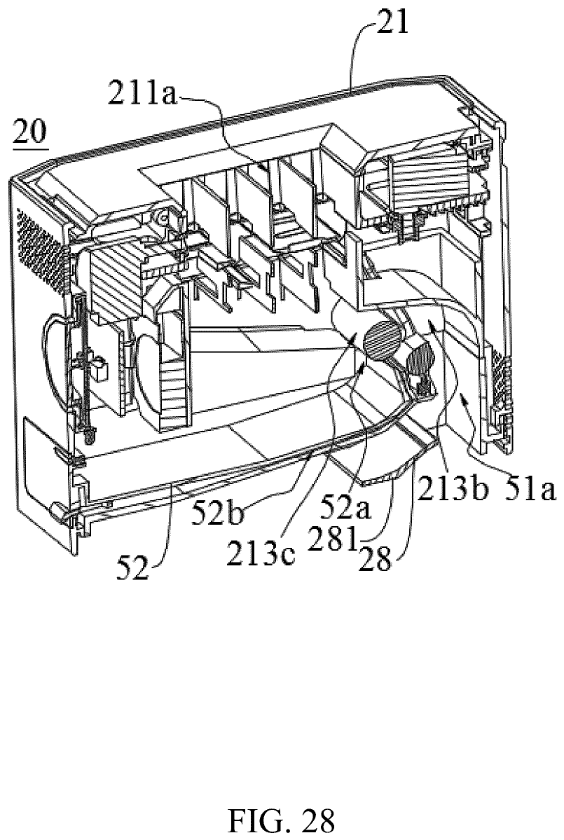

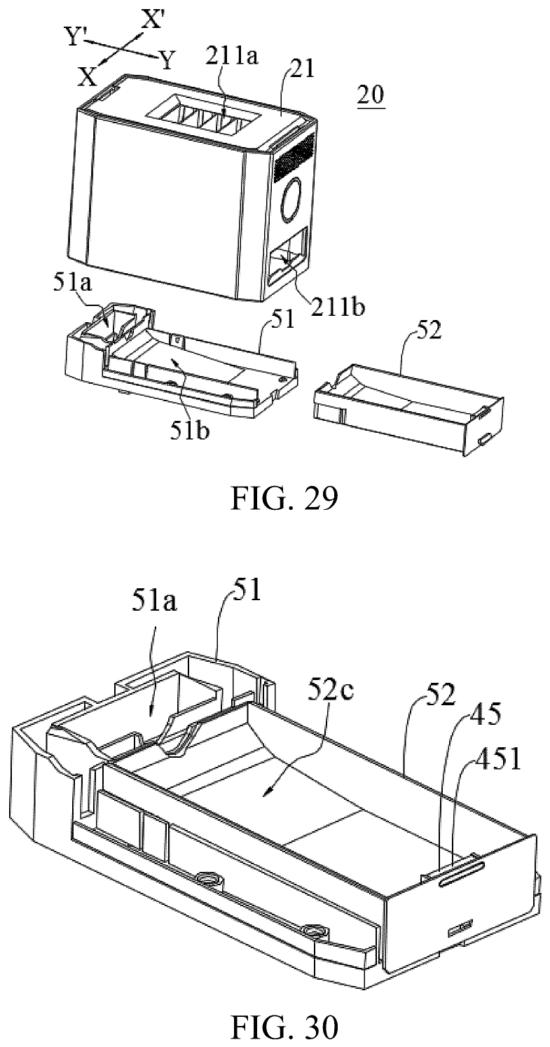

Furthermore, as shown in FIGS. 25-29, the compartment body 211 is also provided with a waste discharging port 211b connected to the chamber of compartment body 211; the charging module 20 also includes a base 51 and a waste compartment 52; the base 51 is embedded at the bottom of compartment body 211 and is detachably connected to the compartment body 211, and the base 51 has a discharging port that is connected to the first opening 213b of the second bracket and used for fully charged batteries to flow outside the chamber of compartment body 211; the waste compartment 52 is used to store waste batteries, and the waste compartment 52 is embedded in the chamber of compartment body 211 through a waste discharging port 211b and connected to the base 51. The waste compartment 52 has a feeding port connected to the second opening 213c of the second bracket 213 and is used for waste batteries to flow into the chamber of waste compartment 52. The waste compartment 52 can perform concertina movement in a direction perpendicular to the plane of waste discharging port 211b, so that the waste compartment 52 has a storage state in which it is retracted inside the chamber of compartment body 211 and an extended state in which it extends outside the chamber of compartment body 211.

The base 51 serves as the bracket for the charging module 20 and, for example, the outer contour shape of the base 51 can be, but is not limited to, rectangular or cylindrical and, for example, the preparation material of the base 51 can be, but is not limited to, plastic cement or one of the plastics.

The discharging port of the base 51a is connected to the first opening 213b of the second bracket 213, so that fully charged batteries can flow through the first opening 213b of the second bracket 213 and flow out from the discharging port of the base 51a to the outside of the chamber of compartment body 211.

The base 51 is embedded at the bottom of compartment body 211 and is detachably connected to the compartment body 211 and in other words, the compartment body 211 is located on the base 51 and is detachably connected to the base 51. The base 51 can be detachably connected to the compartment body 211 through, but is not limited to, at least one screw connection, snap-in connection, or plug-in connection.

The outer contour shape of waste compartment 52 can be, but is not limited to, rectangular or cylindrical; for example, the preparation material for waste compartment 52 can be, but is not limited to, plastic cement or one of the plastics.

The waste batteries flow through the second opening 213c of the second bracket 213 and into the chamber of waste compartment 52 from the feeding port of waste compartment 52.

The waste compartment 52 can, perpendicular to the plane of the waste discharging port 211b of compartment body 211, move towards the direction close to the compartment body 211, so that the waste compartment 52 moves relative to the base 51 to be folded in the chamber of compartment body 211 and is in the above-mentioned folding state. The waste compartment 52 can accommodate waste batteries, such as batteries that do not meet model requirements and are not damaged, batteries that do not meet model requirements and are damaged, batteries that meet model requirements and are damaged, and so on. The waste compartment 52 can move in a direction perpendicular to the plane where the waste discharging port 211b of compartment body 211 is located, away from the charging compartment 21, so that the waste compartment 52 moves relative to the base 51 to the chamber and extends outside of the compartment body 211 and is in the above-mentioned extended state, users then can, from the waste compartment 52, take waste batteries such as batteries that do not meet model requirements and are not damaged, batteries that do not meet model requirements and are damaged, batteries that meet model requirements and are damaged, and so on.

The waste compartment 52 can effectively accommodate waste batteries, so that waste batteries will not occupy the position of batteries that meet model requirements and are not damaged, and charging module 20 can normally charge batteries that meet model requirements and are not damaged. A base 51 is designed to carry the waste compartment 52 and compartment body 211; Detachable connection is designed between the base 51 and the compartment body 211 of warehouse, and when the base 51 or compartment body 211 is damaged, only the damaged parts need to be replaced, resources are saved compared to the replacement of all. The waste compartment 52 is designed to move relative to the base 51 and has a folding state in which it is folded inside the chamber of compartment body 211 and an extending state in which it is located outside the chamber of compartment body 211, and the waste compartment 52 can switch between folding and extending states, making it easier for users to take waste batteries from the waste compartment 52.

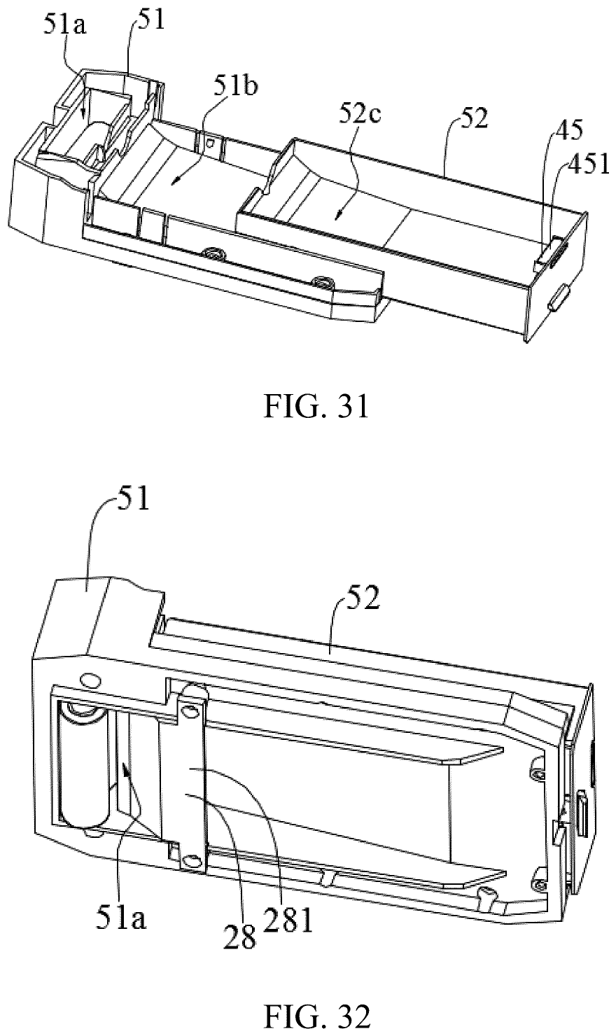

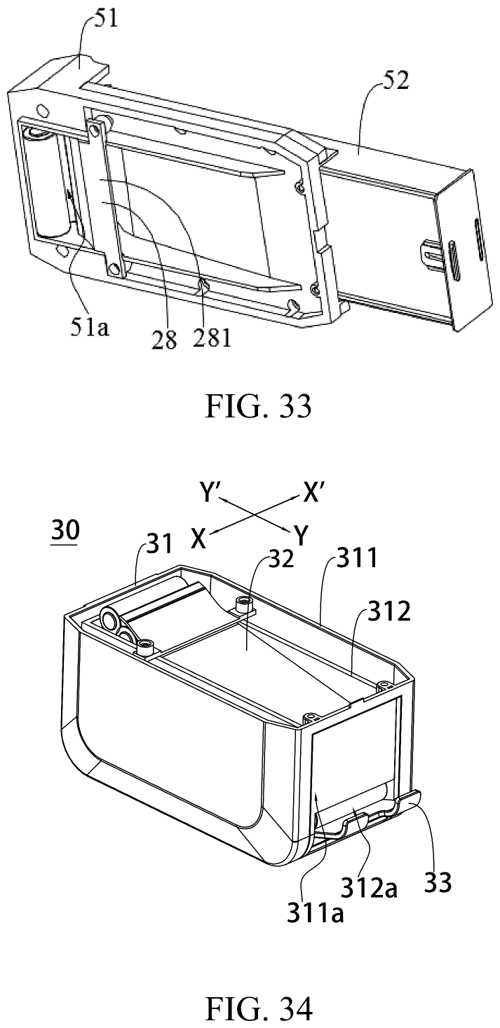

Further, as shown in FIGS. 30-33, the base 51 has a discharge area and a waste area; the discharge area has a discharge port 22a for the outflow of fully charged batteries, the discharge area and the waste area are arranged in the width direction YY′ along the battery charging case 1, and the discharge area is set further away from the waste port 211b of the compartment body 211 compared to the waste area; the waste compartment 52 is set corresponding to the waste area and is slidably connected to the base 51. The waste compartment 52 is disposed corresponding to the waste area and is slidably connected to the base 51. Among them, the waste compartment 52 may be, but is not limited to, slidably connected to the base 51 by means of a slide rail cooperating with the slide groove or a pulley cooperating with the slide groove. In this design, by designing the discharging area and the waste material area to be arranged along the width direction YY′ of the battery charging case 1, and by designing the discharging port 51a of the base 51 to be on the side of the base 51 far away from the waste discharge port 211b of the compartment body 211, and by setting the waste compartment 52 to be on the side of the base 51 close to the waste discharge port 211b of the compartment body 211, so as to reasonably occupy the waste compartment 52 of the base 51, and to reasonably occupy the waste compartment 52 of the base 51, and to reasonably occupy the waste compartment 52 of the base 51. In this way, the waste compartment 52 reasonably occupies the space corresponding to the waste material area of the base 51, and the spatial structure of the base 51 and the waste compartment 52 is enhanced to achieve the purpose of reducing the overall volume of the charging compartment 20.

Further, an outer surface of the waste compartment 52 has a inclined surface 52b near an end of the discharging port 51a of the base 51, and the distance between the inclined surface 52b and the plane where the waste discharging port 211b of the compartment body 211 is located gradually decreases from a side near the discharging port 51a of the base 51 to a side away from the discharging port 51a of the base 51; an area corresponding to the waste area of the base 51 has a support surface 51b facing the feed opening 51b of the compartment body 211, and the support surface 51b and the waste discharging port 51b of the compartment body 211 are located from a side near the discharging port 51a of the base 51 to a side away from the discharging port 51a of the base 51, and the support surface 51b and the support surface 51b are located from a plane of the discharging port 51a of the compartment body 211. The region of the base 51 corresponding to the waste area has a support surface 51b provided facing the inlet of the compartment body 211, and the distance between the support surface 51b and the plane where the waste discharging port 211b of the compartment body 211 is located gradually decreases from the side proximate to the discharging port 51a of the base 51 to the side remote from the discharging port 51a of the base 51; and the support surface 51b resists the beveled surface 52b when the waste compartment 52 is in the above-described stowed state. By designing the outer surface of the waste material compartment 52 near the end of the discharging port 51a of the base 51 as a inclined surface 52b inclined toward the waste discharging port 211b of the compartment body 211, and designing the support surface 51b of the base 51 corresponding to the waste material area as being inclined toward the waste discharging port 211b of the compartment body 211, so that when the waste material compartment 52 is in the stowed state as described above, the support surface 51b and the inclined surface 52b are in contact with the support surface 51b. The waste compartment 52 can provide support to the waste compartment 52 to enhance the stability of the waste compartment 52 resting on the base 51; so that when the waste compartment 52 is switched from the above-mentioned stowed state to the above-mentioned protruding state under the action of an external force, it is convenient for the waste compartment 52 to rely on the tilted support surface 51b to slide toward the waste discharging port 211b of the compartment body 211.

Furthermore, as shown in FIG. 6, the bottom of waste compartment 52 has a guide surface 52c corresponding to the feeding port of waste compartment 52, and from the side close to the discharging port 251 of base 51 to the side far away from the discharging port 251 of base 51, the distance between the guide surface 52 nd and the flat surface of waste discharging port 211b of the compartment body 211 gradually decreases. A guide surface 52c that corresponds to the feeding port of waste compartment 52 is designed at the bottom of waste compartment 52, waste batteries such as the batteries that do not meet model requirements and are not damaged, those that do not meet model requirements and are damaged, and those that meet model requirements and are damaged, etc., flow through the second opening 213c of the second bracket 213 and into the chamber of waste compartment 52 from the feeding port of waste compartment 52, and finally directly fall onto the guide surface 52c. The guide surface 52c can guide waste batteries to roll towards the waste discharging port 211b of compartment body 211 in the waste compartment 52 under the guidance of the guide surface 52c, such that it is easier for users to take out of waste compartment 52 the waste batteries.

Furthermore, the base 51 is detachably connected to the compartment body 211 through screw and/or snap-in connections.

The following describes the working principle of the entire charging module 20: Assuming that the battery installation through slot 212a comprises a first through slot 212a1, a second through slot 212a2, a third through slot 212a3, and a fourth through slot 212a4, for a single charging process of the charging module 20, the four batteries to be charged are dropped into the first through slot 212a1, the second through slot 212a2, and the fourth through slot 212a4 in a one-to-one correspondence, third through slot 212a3, and fourth through slot 212a4. In the initial state, the screening assembly 25 is in a predetermined position, and in the predetermined position, the screening plate 251 of the screening assembly 25 forms an incomplete blockage of the first through slot 212a1, the second through slot 212a2, the third through slot 212a3, and the fourth through slot 212a4, so that the screening ports 251a are staggered from the first through slot 212a1, the second through slot 212a2, the third through slot 212a3, and the fourth through slots 212a4 are staggered. At this time, the model of the battery to be charged that does not meet the requirements falling into the first-through slot 212a1, the second through slot 212a2, the third through slot 212a3, and the fourth through slot 212a4 can pass through the screening port 251a under its own gravity from the smaller gap formed by the imperfectly connected first through slot 212a1, the second through slot 212a2, the third through slot 212a3, and the fourth through slot 212a4 and the screening port 251a through the screening port 251a, so as to realize effective screening of the batteries to be recharged whose models do not meet the requirements; and the batteries to be charged in the first through slot 212a1, the second through slot 212a2, the third through slot 212a3 and the fourth through slot 212a4 of the compliant model will not pass through the smaller gap formed by the incompletely connected first through slot 212a1, the second through slot 212a2, the third through slot 212a3 and the fourth through slot 212a4 and the screening port 251a under its own gravity. The screening port 251a is completed until the first through slot 212a1, the second through slot 212a2, the third through slot 212a3 and the fourth through slot 212a4 are filled with batteries to be recharged in accordance with the requirements of the model.

After the screening assembly is completed, the control assembly controls the first motor 242 to drive the drive bracket 241 to move along the width direction YY′ of the battery charging case 1 so as to drive the two gripping clamps 221 to approach each other along the length direction XX′ of the battery charging case 1 and clamp and fix the two ends of the batteries to be charged from each end of the batteries to be charged, and to make effective contact between the plurality of charging terminals 232a in the group 232 and the electrodes of the plurality of batteries to be charged. The plurality of charging terminals 232a in the charging terminal group 232 form effective contact with the electrodes of the plurality of batteries to be charged, and then the batteries to be charged can be charged. After the charging is completed, the control assembly controls the first motor 242 to drive the drive bracket 241 to move along the width direction YY′ of the battery charging case 1 to drive the two gripping clips 221 away from each other along the length direction XX′ of the battery charging case 1 to return to the initial position, at which time the control assembly will control the second motor 261 to drive the screening assembly 251 along the width direction YY′ of the battery charging case 1, at which time the batteries of the type meeting the requirements in the first pass-through slot 212a1, the second pass-through slot 212a2, the third pass-through slot 212a3, and the fourth pass-through slot 212a4 will pass through the screening port 251a one by one and fall into the passageway 213a of the second bracket in accordance with a preset order (e.g., from left to right or from right to left). 213 within the channel 213a of the second holder. It should be noted that the charging assembly 23 detects the charging current of each battery to be charged during the process of charging the batteries to be charged, and the control assembly determines whether or not the corresponding batteries to be charged are damaged based on the magnitude of the detected charging current.

The control assembly is used to control the classification assembly 29 to switch between the above-described first classification state and the above-described second classification state according to the magnitude of the charging current. If the control assembly determines, based on the magnitude of the charging current, that the battery to be recharged that meets the requirements of the model is a damaged battery to be recharged that cannot be recharged, then at this time, the control assembly controls the classification assembly 29 to be in the second classification state so as to block the first opening 213b of the second bracket 213, and therefore the battery to be recharged that meets the requirements of the model and is damaged flows through the second opening 213c of the second bracket 213, and flows from the inlet of the waste compartment 52 into the chamber of the waste compartment 52. If the control assembly determines, based on the size of the charging current, that the battery to be charged that meets the requirements of the model is an undamaged battery to be charged that is charged, then the control assembly controls the classification assembly 29 to be in a first classification state to block the second opening 213c of the second bracket 213, and the battery to be charged that meets the requirements of the model and that is not damaged is charged by the charging assembly 23 to become a fully-charged battery, and the fully-charged battery flows through the second bracket 213, and flows into the chamber of the waste compartment 52 from the feeding port of the waste compartment 52. The fully charged battery flows through the first opening 213b of the second bracket 213 and out of the chamber of the compartment body 211 from the discharging port of the base 51 and then out of the chamber of the feeding compartment 31 from the feeding port of the feeding compartment 31 of the feeding module 30.

It is to be noted that at the beginning of the screening stage, the control assembly will control the classification assembly 29 to be in the second classification state to cover the first opening 213b of the second holder 213, so that the screened batteries to be charged which do not comply with the requirements in terms of model number, after falling into the channel 213a of the second holder 213, will flow directly through the second opening 213c of the second holder 213 and flow through the inlet of the waste compartment 52 into the chamber of the waste compartment 52. The inlet of the waste compartment 52 will flow into the chamber of the waste compartment 52.

In this way, a single charging process of the charging module 20 can be completed and can be operated cyclically.

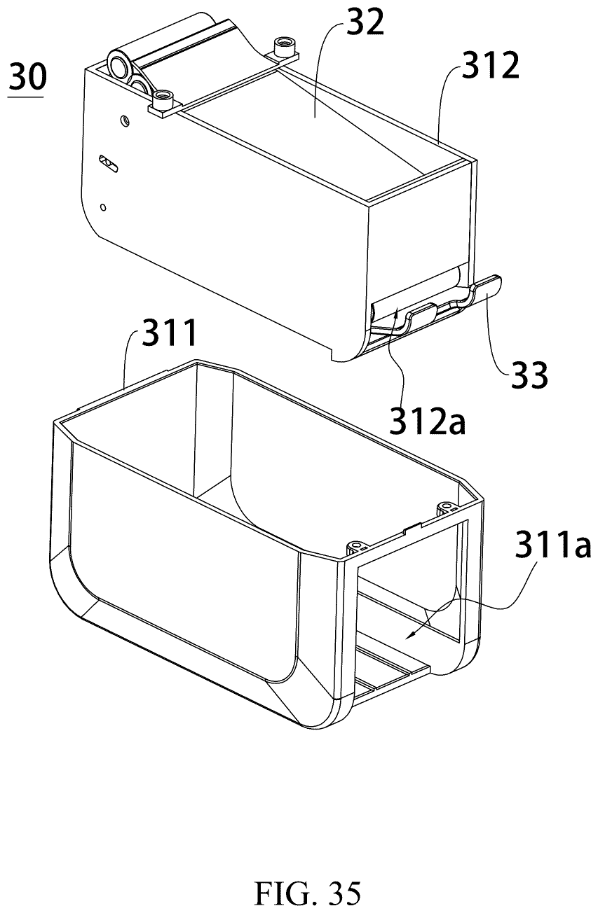

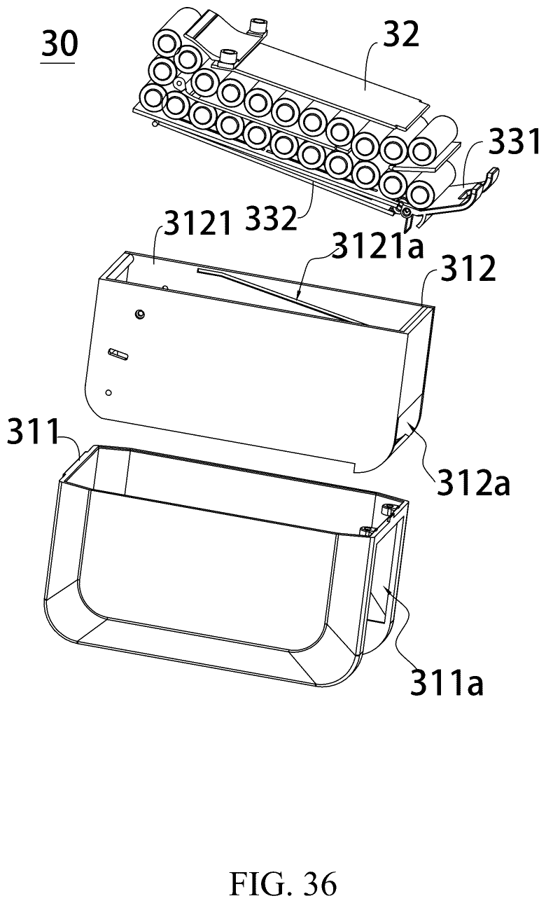

As shown in FIGS. 34-36, the feeding module 30 includes a feeding compartment 31, a carrier structure 32, and a feeding structure 33. The feeding compartment has an inlet and an outlet, and the inlet of the feeding compartment is connected to the outlet of the charging module. The carrier structure is at least partially disposed within the chamber of the discharge compartment and connected to the discharge compartment, and the carrier structure is configured to carry fully charged batteries exiting the discharge port of the charging module in layers. The discharge structure includes a press assembly and a toggle assembly, wherein the press assembly is disposed on the discharge side of the carrier structure, wherein the press assembly is connected to the discharge compartment and partially extends out of the chamber of the discharge compartment via the discharging port of the discharge compartment, and wherein the toggle assembly is disposed within the chamber of the discharge compartment and connected to the press assembly and the discharge compartment. Wherein the press assembly is configured to move the toggle assembly by rotation so that the toggle assembly drives a fully charged battery out of the discharging port of the discharge compartment into the chamber of the discharge compartment.

Wherein the discharge compartment 31 serves as a housing for the discharge module 30; the material used in the preparation of the discharge compartment 31 may, but is not limited to, be PC (polycarbonate, Polycarbonate);

The discharge compartment 31 has a discharging port 312a, i.e., an opening of the discharge compartment 31 for the fully charged batteries to flow out of the chamber of the discharge compartment 31; the shape of the discharging port 312a may be, but is not limited to, a rectangular shape.

The carrier structure 32 serves as a structural member for carrying the fully charged batteries in the feeding module 30, and the fully charged batteries flowing out of the discharging port of the charging module 20 of the battery charging case 1 will fall directly onto the carrier structure 32 after flowing out of the feeding opening of the discharge compartment 31 into the chamber of the discharge compartment 31.

At least a portion of the carrier structure 32 is disposed within the chamber of the discharge compartment 31.

The carrier structure 32 is coupled to the discharge compartment 31; the carrier structure 32 may be, but is not limited to, detachably coupled to the discharge compartment 31 by at least one of screwing, snapping, or plugging; the carrier structure 32 may be, but is not limited to, non-detachably coupled to the discharge compartment 31 by gluing.

The carrier structure 32 is configured to carry the fully charged batteries flowing out of the discharge port of the charging module 20 of the battery charging case 1 in a layered manner, i.e., the fully charged batteries flowing out of the discharge port of the charging module 20 of the battery charging case 1 flow from the feeding port of the discharge compartment 31 into the chamber of the discharge compartment 31 and then fall down onto the carrier structure 32, and the carrier structure 32 is relied upon to realize layered arrangement of a plurality of fully charged batteries within the discharge compartment 31; the carrier structure 32 may be, but is not limited to, not detachably connected with the discharge compartment 31 by means of adhesive connection. A plurality of fully charged batteries are arranged in layers within the discharge compartment 31; for example, the plurality of fully charged batteries may be arranged in one layer, two layers, three layers, etc. within the chamber of the discharge compartment 31 relying on the carrier structure 32, depending on the number of fully charged batteries that enter the chamber of the discharge compartment 31.

The discharging structure 33 serves as a structural member in the discharging module 30 for feeding a fully charged battery out of the discharge port 312a of the above-described discharge compartment 31 to the outside of the chamber of the discharge compartment 31; the discharging structure 33 includes a pressing assembly 331 and a toggle assembly 332.

The pressing assembly 331 is adapted to rotate under the action of an external force; when the pressing assembly 331 includes a magnet, the action of the external force to which the pressing assembly 331 is subjected corresponds to a magnetic adsorption force.

The press assembly 331 is located on the discharge side (side near the discharging port 312a) of the carrier structure 32, and the press assembly 331 is connected to the discharge compartment 31 and partially protrudes outside the chamber of the discharge compartment 31 via the discharging port 312a of the discharge compartment 31.

The toggle assembly 332 is adapted to push against a fully charged battery carried on the carrier structure 32 under the driving of the press assembly 331, so that the fully charged battery rolls toward the discharging port 312a of the discharge compartment 31 under the pushing action thereof, thereby causing the fully charged battery to flow out of the chamber of the discharge compartment 31 through the discharging port 312a of the discharge compartment 31.

The toggle assembly 332 is disposed within the chamber of the discharge compartment 31 and is coupled to the press assembly 331 and the discharge compartment 31; the toggle assembly 332 may be, but is not limited to, detachably coupled to the discharge compartment 31 by at least one of screwing, snapping, or inserting; and the toggle assembly 332 may be, but is not limited to, non-detachably coupled to the discharge compartment 31 by means of a glued connection.

The press assembly 331 is configured to rotate to move the toggle assembly 332 so that the toggle assembly 332 drives the fully charged battery out of the discharging port 312a of the discharge compartment 31 to the outside of the chamber of the discharge compartment 31; by applying an external force to the press assembly 331, the press assembly 331 is rotatable under the action of such an external force, and the toggle assembly 332 will be pushed upwardly by the driving of the press assembly 331 The fully charged battery carried on the carrier structure 32 causes the fully charged battery to roll toward the discharge port 312a of the discharge compartment 31 under the pushing action thereof, thereby causing the fully charged battery to flow out of the chamber of the discharge compartment 31 from the discharge port 312a of the discharge compartment 31. Since there is uncertainty when the fully charged battery flows out of the discharge port of the charging module 20 of the battery charging case 1 and falls onto the carrier structure 32 from the feeding module of the discharge compartment 31, for example, the fully charged battery may have a displacement deviation that causes it to get stuck between two oppositely disposed inner walls of the discharge inner compartment 312 after falling onto the carrier structure 32, at this time, a constant external force may be exerted on the pressing assembly 331, and the pressing assembly 331 may be pressed by the constant external force, and the pressing assembly 331 may be pressed by the constant external force. At this time, an external force may be continuously applied to the pressing assembly 331, the pressing assembly 331 may reciprocate under the action of the continuous external force, and the toggle assembly 332, driven by the reciprocating action of the pressing assembly 331, will continuously push the fully charged battery carried on the carrier structure 32, so as to correct the above displacement deviation of the fully charged battery under the action of the continuous pushing, so as to make the fully charged battery break free from the holding of the discharging compartment 31 and roll towards the discharging port 312a of the discharging compartment 31, thereby causing the fully charged battery to be removed from the discharging compartment 31 from the discharging port 312a of the discharging compartment 31. Thereby, the fully charged battery flows out of the chamber of the discharge compartment 31 from the discharging port 312a of the discharge compartment 31.

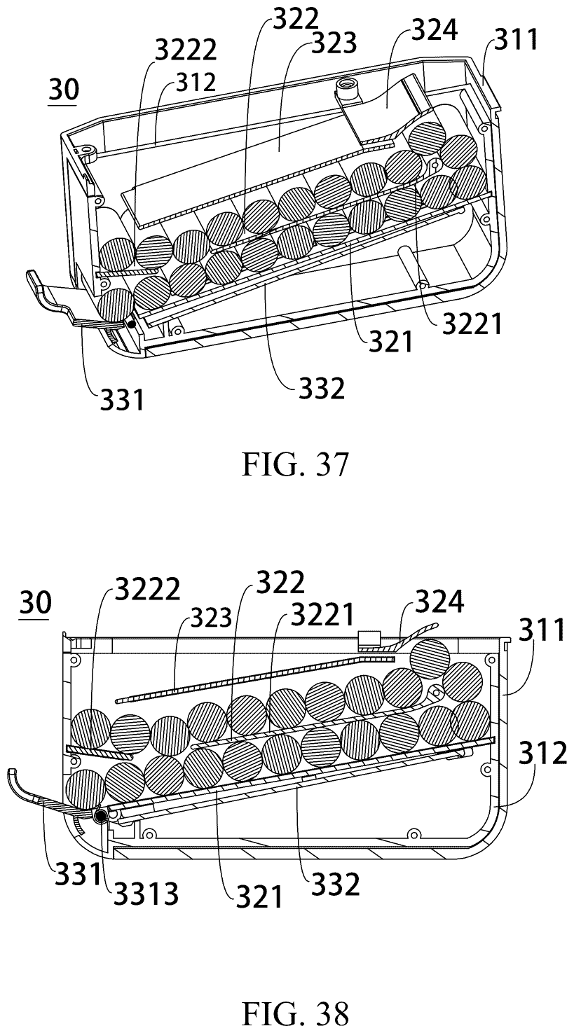

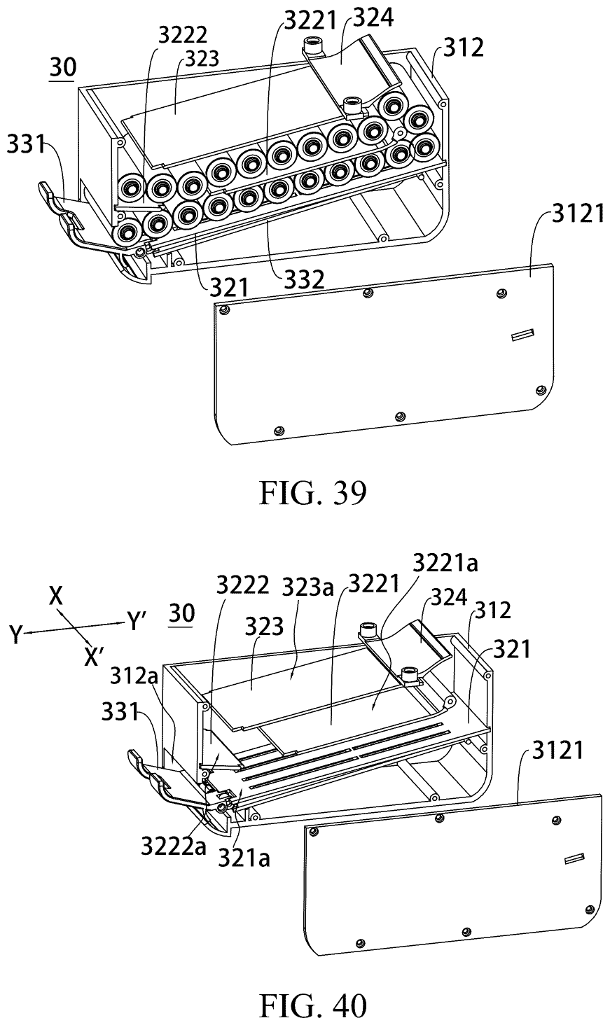

Further, as shown in FIGS. 37-40, the carrier structure 32 includes a first carrier plate 321 and a second carrier plate 322; the first carrier plate 321 is disposed in a chamber of the discharge compartment 31, and an end of the first carrier plate 321 that is far away from the discharging port 312a of the discharge compartment 31 is connected to a side wall of the discharge compartment 31, and the end of the first carrier plate 321 that is close to the discharging port 312a of the discharge compartment 31 serves as an outlet side of the carrying outlet side of the discharge structure 32; the second carrier plate 322 is further away from the bottom wall of the discharge compartment 31 than the first carrier plate 321 and is spaced apart from the first carrier plate 321 to form a first sandwich for holding the fully charged battery, the second carrier plate 322 is connected to the side wall of the discharge compartment 31, and the second carrier plate 322 has a notch, so that the fully charged battery carried on the second carrier plate 322 can be dropped onto the first carrier plate 321 through the notch. the first carrier plate 321.

Wherein, the first carrier plate 321 extends along the width direction YY′ of the battery charging case 1, and the first carrier plate 321 may be an elastic carrier plate or a rigid carrier plate; when the first carrier plate 321 is an elastic carrier plate, the end of the first carrier plate 321 that is away from the discharging port 312a of the discharge compartment 31 is fixedly coupled with the side wall of the discharge inner compartment 312; when the first carrier plate 321 is a rigid carrier plate, one end of the first carrier plate 321 away from the discharging port 312a of the discharge compartment 31 is rotationally connected to the side wall of the discharge inner compartment 312. The side of the first carrier plate 321 near the discharging port 312a of the discharge compartment 31 is provided as the discharge side of the carrier structure 32 corresponding to the discharging port 312a of the discharge compartment 31. Similarly, the second carrier plate 322 extends along the width direction YY′ of the battery charging case 1; when the second carrier plate 322 is an elastic carrier plate, the second carrier plate 322 is fixedly connected to the side wall of the discharge inner compartment 312 of the discharging compartment 31; when the second carrier plate 322 is a rigid carrier plate, the second carrier plate 322 is rotationally connected to the side wall of the discharge inner compartment 312 of the discharging compartment 31. The second carrier plate 322 is fixedly connected to the side wall of the discharge compartment 31. The “notch” is an opening in the second carrier plate 322 for a fully charged battery carried on the second carrier plate 322 to fall onto the first carrier plate 321. The first carrier plate 321 is spaced apart from the second carrier plate 322 to form the first sandwich as described above, and the fully charged battery carried on the first carrier plate 321 is inside the first sandwich.

By designing the first carrier plate 321, the fully charged batteries flowing out of the discharge port of the charging module 20 of the battery charging case 1 and flowing in from the feeding port of the discharge compartment 31 may fall directly onto the first carrier plate 321, so that the first carrier plate 321 provides support for the fully charged batteries carried thereon; by designing the second carrier plate 322, the fully charged batteries flowing out of the discharge port of the charging module 20 of the battery charging case 1 and flowing in from the discharge compartment 31 may fall directly onto the second carrier plate 322, so that the second carrier plate 322 provides support for the fully charged batteries carried thereon; by designing the second carrier plate 322, the fully charged batteries flowing out of the discharge port of the charging module 20 of the battery charging case 1 and flowing in By designing the second carrier plate 322, the fully charged batteries flowing out of the discharge port of the charging module 20 of the battery charging case 1 and flowing in from the feeding module 31 of the discharge compartment 31 may fall onto the second carrier plate 322 directly, so that the second carrier plate 322 provides support for the fully charged batteries carried thereon; by designing the first carrier plate 321 and the second carrier plate 322 to be spaced apart to form a first interlayer, so as to realize that the first carrier plate 321 and the second carrier plate 322 have a direct effect on the fully charged batteries flowing out of the discharge port of the charging module 20 of the battery charging case 1 and flowing in from the feeding module 31 of the discharge compartment 31, so as to realize that the second carrier plate 322 has a direct effect on the fully charged batteries carrying therein. The first carrier plate 321 and the second carrier plate 322 are layered to carry fully charged batteries flowing out of the discharge port of the charging module 20 of the battery charging box 1 and flowing in from the feeding port of the discharge compartment 31.

Further, the first carrier plate 321 has a first carrier surface 321a disposed backwardly to the bottom wall of the discharge compartment 31, the first carrier surface 321a is used to carry the fully charged battery, and the distance between the first carrier surface 321a and the bottom wall of the discharge compartment 31 gradually increases from the side proximate to the discharging port 312a of the discharge compartment 31 to the side remote from the discharging port 312a of the discharge compartment 31. Wherein, the first carrier surface 321a may be a flat surface, a curved surface, or a combination of a flat surface and a curved surface. By designing the first carrier surface 321a as a sloping surface inclined toward the discharging port 312a of the discharge compartment 31, the first carrier surface 321a has a guiding effect, so that the pressing assembly 331 rotates under an external force to drive the toggle assembly 332 to push the fully charged battery carried on the first carrier plate 321, so that the fully charged battery carried on the first carrier plate 321 can be more smoothly oriented toward the discharging port 313a by the pushing action thereof, so that the fully charged battery carried on the first carrier plate 321 can be more smoothly oriented toward the discharging port 313a by the pushing action thereof. The fully charged battery carried on the first carrier plate 321 can be rolled towards the discharging port 312a of the discharge compartment 31 more smoothly, thereby making it easier for the fully charged battery to flow out of the chamber of the discharge compartment 31 from the discharging port 312a of the discharge compartment 31.

Further, the second carrier plate 322 includes a first subplate 3221 and a second subplate 3222; the first subplate 3221 is connected to a side wall of the discharge compartment 31, and a side edge of the first subplate 3221 that is far away from the outlet 312a of the discharge compartment 31 is spaced apart from the side wall of the discharge compartment 31 so as to form a first gap; a fully-charged battery that flows out of the discharge outlet of the charging module 20 can fall through the first gap onto the first subplate 3221 and the first carrier plate 321; the second subplate 3222 is closer to the discharging port 312a of the discharge compartment 31 and connected to the side wall of the discharge compartment 31 compared to the first subplate 3221, and a side edge of the second subplate 3222 that is away from the discharging port 312a of the discharge compartment 31 is spaced from a side edge of the first subplate 3221 that is close to the discharging port 312a of the discharge compartment 31 to form the notch described above.

wherein the first subplate 3221 extends along the width direction YY′ of the battery charging case 1, the first subplate 3221 may be, but is not limited to, fixedly or rotationally connected to a side wall of the discharge inner compartment 31 of the discharge compartment 31 via a shaft; the two side walls of the discharge inner compartment 312 disposed oppositely along the length direction XX′ of the battery charging case 1 are provided with The two side walls of the discharging inner compartment 312 are provided with a first slot (not shown in the drawings) extending along the width direction YY′ of the battery charging case 1, and the two side edges of the first subplate 3221 disposed along the length direction XX′ of the battery charging case 1 are respectively engaged with the first slots on the two oppositely disposed side walls of the discharging compartment 31. The second subplate 3222 extends along the width direction YY′ of the battery charging case 1; when the second subplate 3222 is an elastic plate, one end of the second subplate 3222 away from the discharging port 312a of the discharging compartment 31 is fixedly coupled with a side wall of the discharging inner compartment 312; when the second subplate 3222 is a rigid plate, one end of the second subplate 3222 away from the discharging port 312a of the discharging compartment 31 is fixedly coupled with the side wall of the discharging inner compartment 31. 312a is rotationally connected to the side wall of the discharge inner compartment 312. One edge of the first subplate 3221 near the discharging port 312a of the discharge compartment 31 is spaced from one edge of the second subplate 3222 away from the discharging port 312a of the discharge compartment 31 so as to form a gap as described above, and fully charged batteries carried on the first subplate 3221 or the second subplate 3222 may fall directly from the gap onto the first carrier plate 321 as described above.

By spacing a side edge of the first subplate 3221 away from the discharging port 312a of the discharge compartment 31 from a side wall of the discharge compartment 31 to form a first gap, so that a fully charged battery flowing out of the discharging port of the charging module 20 can fall through the first gap onto the first subplate 3221 and the first carrier plate 321; and by designing the second carrier plate 322 to be independent of each other as the first subplate 3221 and the second By designing the second carrier plate 322 as mutually independent first subplate 3221 and second subplate 3222, the edge of one side of the first subplate 3221 near the discharging port 312a of the discharge compartment 31 and the edge of one side of the second subplate 3222 away from the discharging port 312a of the discharge compartment 31 are spaced apart to form a gap, so that the fully charged batteries carried on the first subplate 3221 or the second subplate 3222 can fall from the gap to the first carrier plate 321 directly, and the pressing component 331 The press assembly 331 rotates under an external force to drive the toggle assembly 332 to push the fully charged battery carried on the first carrier plate 321, so that the fully charged battery carried on the first carrier plate 321 can roll toward the discharge port 312a of the discharge compartment 31 under the pushing action thereof, and thereby cause the fully charged battery to flow out of the chamber of the discharge compartment 31 from the discharge port 312a of the discharge compartment 31.

As shown in FIG. 40, in one embodiment, the first subplate 3221 has a second carrier surface 3221a disposed backwardly to the bottom wall of the discharge compartment 31, the second carrier surface 3221a is used to carry fully charged batteries, and the distance between the second carrier surface 3221a and the bottom wall of the discharge compartment 31 is gradually increased from the side proximate to the discharging port 312a of the discharge compartment 31 to the side remote from the discharging port 312a of the discharge compartment 31. the distance between the second carrier surface 3221a and the bottom wall of the discharge compartment 31 gradually increases. Wherein, the second carrier surface 3221a may be a flat surface, a curved surface, or a combination of a flat surface and a curved surface. By designing the second carrier surface 3221a as a sloping surface inclined toward the discharging port 312a of the discharge compartment 31, the second carrier surface 3221a has a guiding effect, so that a fully charged battery carried on the first subplate 3221 is more likely to roll toward the gap and fall from the gap onto the first carrier plate 321.

In another embodiment, the second subplate 3222 has a third carrier surface 3222a disposed backwardly to the bottom wall of the discharge compartment 31, the third carrier surface 3222a is used to carry the fully charged batteries, and the distance between the third carrier surface 3222a and the bottom wall of the discharge compartment 31 is progressively decreased from the side proximate to the discharging port 312a of the discharge compartment 31 to the side remote from the discharging port 312a of the discharge compartment 31 decreases. Wherein, the third carrier surface 3222a may be a flat surface, a curved surface, or a combination of a flat surface and a curved surface. By designing the third carrier surface 3222a as a sloping surface inclined toward the discharging port 312a of the discharge compartment 31, the third carrier surface 3222a has a guiding effect, so that the fully charged batteries carried on the second subplate 3222 are more likely to roll toward the gap and fall from the gap onto the first carrier plate 321.

In other embodiments, the second carrier plate 322 may also be a complete plate-like structure, in which case the second carrier plate 322 is provided with a through-hole, the through-hole being the aforementioned notch.

Further, the carrier structure 32 further includes a third carrier plate 323, the third carrier plate 323 being further away from the bottom wall of the discharge compartment 31 than the second carrier plate 322 and spaced apart from the second carrier plate 322 to form a second mezzanine layer for the charged battery, the third carrier plate 323 being connected to the side wall of the discharge compartment 31; the third carrier plate 323 being close to the edge of the side edge of the discharging port 312a of the discharge compartment 31 spaced from the side wall of the discharge compartment 31 to form a second gap, and a fully charged battery carried on the third carrier plate 323 may fall through the second gap onto the second carrier plate 322.

Wherein, the third carrier plate 323 extends along the width direction YY′ of the battery charging case 1, and the third carrier plate 323 may be, but is not limited to, fixedly or rotationally coupled to the side wall of the discharge inner compartment 312 by an axle; the two side walls of the discharge inner compartment 312, which are disposed opposite to each other along the length direction XX′ of the battery charging case 1, are provided with a battery charging plate 322 that is fixedly or rotationally coupled to the side wall of the discharge inner compartment 312 along the width direction YY′ of the battery charging case 1. YY′ of the width direction YY′ of the battery charging case 1, and the two side edges of the third carrier plate 323 disposed opposite to each other along the length direction XX′ of the battery charging case 1 are respectively engaged with the second slot 3121a on the two oppositely disposed side walls of the discharging compartment 31.

It is to be noted that the second subplate 3222 is provided corresponding to the second gap, so that the fully charged battery carried on the third carrier plate 323 may first fall onto the second subplate 3222 from the said second gap, and the second subplate 3222 plays a buffering role for the fully charged battery to avoid the fully charged battery carried on the third carrier plate 323 from falling through the second gap and the said gap directly onto the first carrier plate 321, and so that the second subplate 3222 is not connected with the second slot 3121a on the two opposing side walls of the discharge compartment 31 carrier plate 321, so that the first carrier plate 321 can be buffered and protected.

Further, the third carrier plate 323 has a fourth carrier surface 323a disposed backwardly to the bottom wall of the discharge compartment 31, the fourth carrier surface 323a is used to carry the fully charged battery, and the distance between the fourth carrier surface 323a and the bottom wall of the discharge compartment 31 gradually increases from the side proximate to the discharging port 312a of the discharge compartment 31 to the side remote from the discharging port 312a of the discharge compartment 31. Wherein, the fourth carrier surface 323a may be a flat surface, a curved surface, or a combination of a flat surface and a curved surface. By designing the fourth carrier surface 323a as a sloping surface inclined toward the discharging port 312a of the discharge compartment 31, the fourth carrier surface 323a is oriented so that the fully charged battery carried on the third carrier plate 323 is more likely to roll toward the second gap and fall from the second gap onto the second carrier plate 322.

Further, as shown in FIGS. 37-FIG. 40, the carrier structure 32 further includes a guide plate 324, the guide bar being provided on the side of the third carrier plate 323 away from the discharging port 312a of the discharge compartment 31, so that the fully charged batteries flowing out of the discharging port of the charging module 20 of the battery charging case 1 can be dropped onto the third carrier plate 323 via the guide plate 324. Wherein, the guide plate 324 is provided adjacent to the discharging port of the charging module 20 of the battery charging case 1, and the guide plate 324 may be mounted and fixed to the discharge inner compartment 312, or may be mounted and fixed to the bottom of the charging compartment of the charging module 20 (e.g., fixed by screws). By designing the guide plate 324, the guide plate 324 has a guiding function, and the fully charged batteries flowing out of the discharge port of the charging module 20 of the battery charging case 1 can be dropped onto the third carrier plate 323 via the guide plate 324.

It is to be noted that the movement trajectory of the fully charged battery flowing out of the discharge port of the charging module 20 of the battery charging case 1 in the discharge compartment 31 is not homogeneous, but regardless of the movement of the fully charged battery in the discharge compartment 31, the fully charged battery firstly moves to the first carrier plate 321, and after the fully charged battery fills up the aforesaid first compartment, the fully charged battery then moves to the second carrier plate 322, and after the fully charged battery fills up the aforesaid third carrier plate 322, the fully charged battery moves to the third carrier plate 323, and the fully charged battery moves to the third carrier plate 322, and the fully charged battery moves to the third carrier plate 322, and the fully charged battery moves to the third carrier plate 323. 322, and after the fully charged battery fills up the above mentioned second sandwich layer, the fully charged battery finally moves to the third carrier plate 323. Of course, the pressing assembly 331 drives the toggle assembly 332 to push the fully charged batteries under the action of external force, and the fully charged batteries carried on the first carrier plate 321 flow out from the discharge port 312a of the discharge compartment 31 to the outside of the chamber of the discharge compartment 31; however, as the fully charged batteries carried on the second carrier plate 322 or the third carrier plate 323 fall to the first carrier plate 321, the pressing assembly 331 moves to the second carrier plate 322, and after the second carrier plate 322 is filled with the second sandwich layer as described above, the fully charged batteries finally move to the third carrier plate 323. However, as the fully charged battery loaded on the second carrier plate 322 or loaded on the third carrier plate 323 falls onto the first carrier plate at a later stage, the pressed assembly 331 drives the toggle assembly 332 to push the fully charged battery under the action of an external force, and the fully charged battery that flows out of the chamber of the discharging compartment 31 from the outlet 312a of the discharging compartment 31 may not necessarily be the fully charged battery that was loaded on the first carrier plate 321 at the very beginning, and it may be the fully charged battery that fell onto the first carrier plate 321 from the second carrier plate 322 or the third carrier plate 323 at a later stage plate 321.

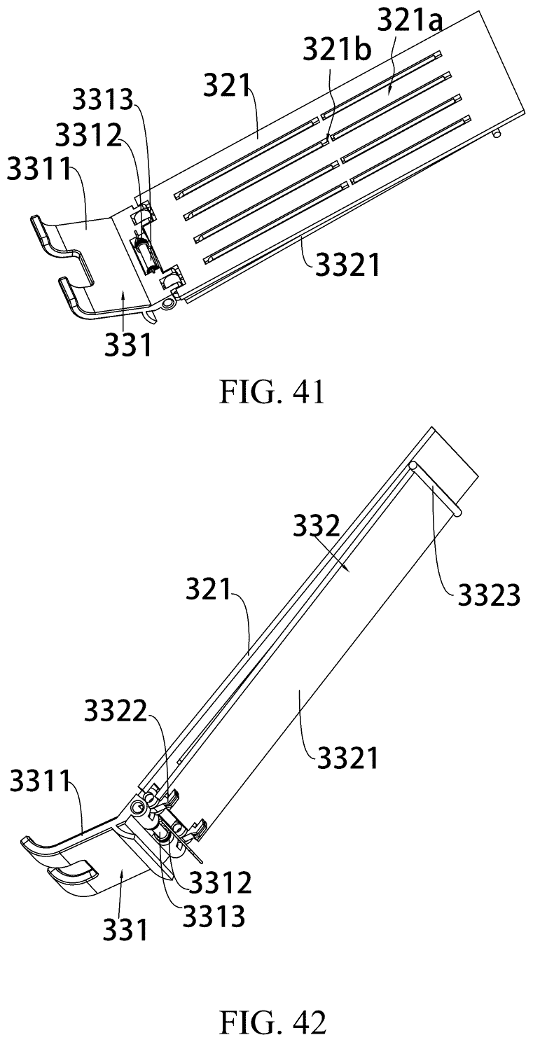

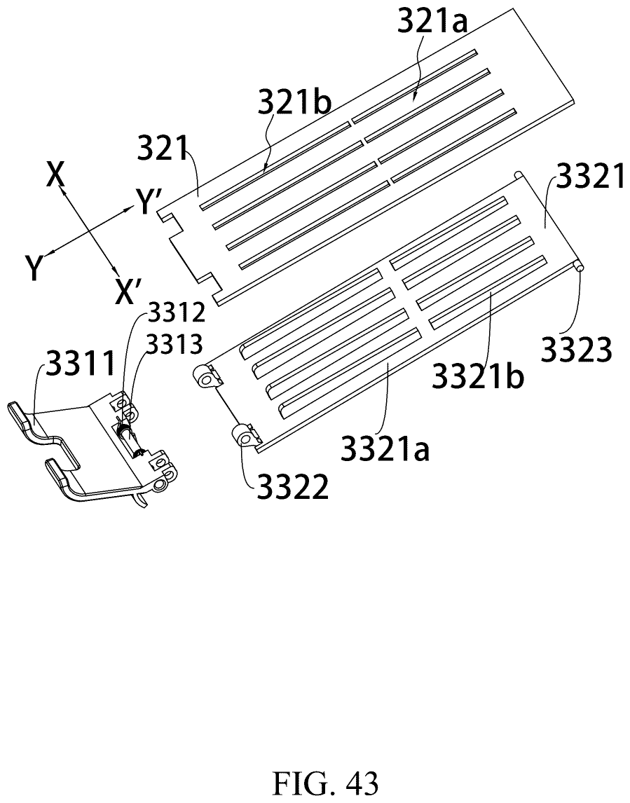

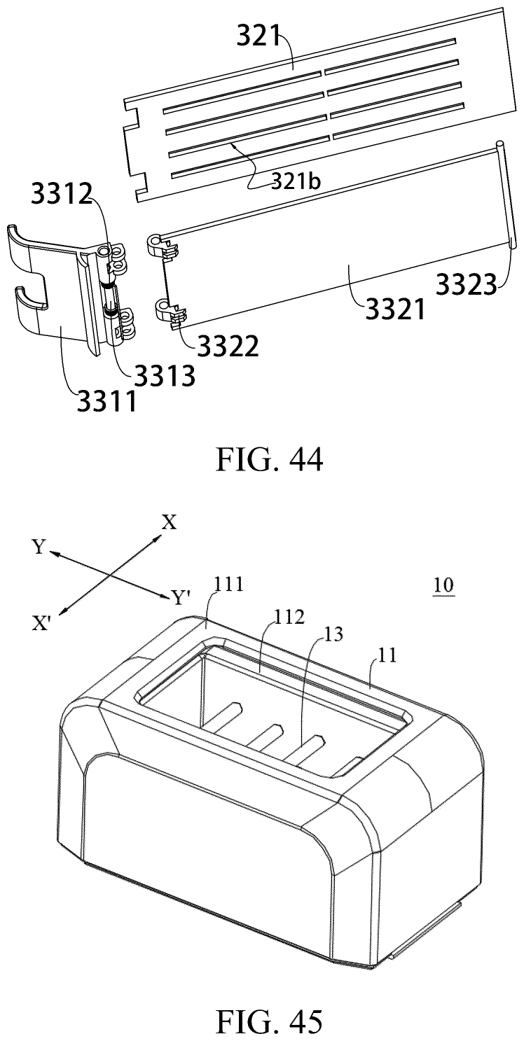

Further, as shown in FIGS. 41-FIG. 44, the pressing assembly 331 includes a press member 3311 and an resilient member 3312; the press member 3311 is rotationally connected to the discharge compartment 31 and partially protrudes out of the chamber of the discharge compartment 31 via the discharging port 312a of the discharge compartment 31, and the press member 3311 is rotationally connected to the end of the toggle assembly 332 proximate to the discharging port 312a of the discharge compartment 31; the resilient member 3312 is rotationally connected to the press member 3311 and partially protrudes out of the chamber of the discharge compartment 31 via the discharging port 312a of the discharge compartment 31; and the resilient member 3312 is connected to the press member 3311 and can produce elastic deformation in the direction of rotation of the press member 3311; the press member 3311 can be rotated under the action of the press force, and the toggle assembly 332 rotationally connected thereto can be driven by the rotation, so that the toggle assembly 332 pushes against the fully charged batteries carried on the above-described first carrier plate 321, so that the fully charged batteries can be pushed out of the discharge compartment 31 from the outlet compartment 31 by the press member 3311, and the toggle assembly 332 can be pushed against the fully charged batteries 3311 to flow out of the discharge port 312a of the discharge compartment 31 to the outside of the chamber of the discharge compartment 31.

Wherein, the press member 3311 serves as a transmission element of the press assembly 331; along the length direction XX′ perpendicular to the battery charging case 1, the cross-section of the press member 3311 may be in the shape of a “J-shape”, wherein the press member 3311 corresponds to a hook-shaped press plate or a hook-shaped press grille. The resilient member 3312 serves as a resetting element of the press member 3311; the resilient member 3312 may be, but is not limited to, removably fixedly connected to the press member 3311 by means of screwing, inserting, or snap-fitting; the resilient member 3312 may be, but is not limited to, fixedly connected to the press member 3311 in a non-removable manner by means of gluing.

The press member 3311 may rotate under the action of the pressing force and cause the resilient member 3312 to produce elastic deformation in the direction of rotation around the press member 3311, and when the pressing force acting on the press member 3311 is withdrawn, the press member 3311 rotates back to the initial position under the action of the elastic restoring force of the elastic deformation produced by the resilient member 3312, so as to realize the reset of the press member 3311, so that the next time the press member 3311 is pressed, it may be fixedly connected in a non-removable manner so as to facilitate the next pressing of the press member 3311.

Specifically, the pressing assembly 331 further includes a second rotating shaft 3313, the press member 3311 being rotationally connected to the side wall of the discharge inner compartment 312 via the second rotating shaft 3313; the resilient member 3312 includes a torsion spring, the torsion spring being set on the second rotating shaft 3313, and one end of the torsion spring being fixedly connected to the second rotating shaft 3313, and the other end of the torsion spring being resisted to the bottom wall of the discharge compartment 31. By designing the second rotary axis 3313 to realize the rotational connection between the press member 3311 and the side wall of the discharge compartment 31; by designing the torsion spring, the press member 3311 rotates under the action of the pressing force, and the rotation of the press member 3311 drives the torsion spring connected thereto to produce elastic deformation in the direction of rotation around the press member 3311, and when the pressing force acting on the press member 3311 is withdrawn, the press member 3311 is rotated in the direction of rotation by the torsion spring, and the press member 3311 is rotated in the direction of rotation by the torsion spring 3311 is reversed to the initial position under the action of the elastic restoring force of the elastic deformation produced by the torsion spring, thereby realizing the reset of the press member 3311 so as to facilitate the next pressing of the press member 3311.

Of course, in some other embodiments, the resilient member 3312 may also be a spring, with one end of the spring being fixedly connected to the press member 3311 and the other end of the spring being fixedly connected to the bottom wall of the discharge compartment 31.

Further, the first carrier plate 321 is provided with a through slot 321b extending along a width direction YY′ of the battery charging case 1; the toggle assembly 332 includes a toggle member 3321 and a connecting member 3322; the toggle member 3321 is located on a side of the first carrier plate 321 facing the bottom wall of the discharge compartment 31, and the toggle member 3321 is located away from the discharging port 312a of the discharge compartment 31 The toggle member 3321 is located on the side of the first carrier plate 321 facing the bottom wall of the discharge compartment 31, and the end of the toggle member 3321 away from the discharging port 312a of the discharge compartment 31 is connected to the side wall of the discharge compartment 312; the connecting member 3322 is provided at the end of the toggle member 3321 near the discharging port 312a of the discharge compartment 31 and is rotationally connected to the press member 3311; the toggle member 3321 is partially disposed in the through slot 321b.

Wherein, when the number of the through slots 321b is one, the one through slot 321b is an elongate through slot 321b extending along the width direction YY′ of the battery charging case 1; when the number of the through slots 321b is a plurality of through slots 321b, the plurality of through slots 321b is a plurality of elongate through slots 321b extending along the width direction YY′ of the battery charging case 1, and the plurality of elongate through slots 321b are arranged in an M row*N column matrix along the length direction XX′ and the width direction YY′ of the battery charging case 1 321b, and the plurality of elongate through slots 321b are arranged in an M-row*N-column matrix along the length direction XX′ of the battery charging case 1 and the width direction YY′ of the battery charging case 1. The toggle member 3321 is used for toppling the fully charged battery carried on the above-described first carrier plate 321. The connecting member 3322 is used to realize the rotational connection between the toggle member 3321 and the press member 3311, the connecting member 3322 may be, but is not limited to, a connecting seat or a connecting claw holder, the connecting member 3322 is rotationally connected to the press member 3311 by a rotational axis, and the connecting member 3322 may be, but is not limited to, formed into a one-piece structure with the toggle member 3321 by means of injection molding or 3D printing.

By designing the toggle member 3321 and the connecting member 3322, the toggle member 3321 is rotationally connected to the press member 3311 via the connecting member 3322, the press member 3311 rotates under the action of the press force, and the rotation of the press member 3311 drives the toggle member 3321 rotationally connected thereto to deflect in the direction of backwardly departing from the bottom wall of the discharge compartment 31, so as to cause the toggle member 3321 to be embedded in the through slot 321b of the first load plate The portion of the toggle member 3321 embedded in the through slot 321b of the first carrier plate 321 extends out of the through slot 321b and pushes against the fully charged batteries carried on the above-described first carrier plate 321, so that the fully charged batteries roll toward the outlet 312a of the discharging compartment 31 under the pushing force of the toggle member 3321 and flow out from the outlet 312a of the discharging compartment 31 through the push member 3311 to the outside of the chamber of the discharging compartment 31.

Further, the toggle member 3321 comprises a toggle plate 3321a and a toggle flange 3321b; the end of the toggle plate 3321a away from the discharging port 312a of the discharge compartment 31 is connected to a side wall of the inner discharge compartment 312, and the end of the toggle plate 3321a proximate to the discharging port 312a of the discharge compartment 31 is rotationally connected to the press member 3311 via the connecting member 3322; the toggle flange 3321b is connected to the toggle plate 3321a is connected to the side of the toggle plate 3321b backwardly to the bottom wall of the discharge compartment 31, the toggle flange 3321b is provided corresponding to the through slot 321b and embedded in the through slot 321b; the press member 3311 is rotated under an external force to drive the toggle plate 3321a to rotate in the direction backwardly away from the bottom wall of the discharge compartment 31, so as to cause the toggle flange 3321b to penetrate out of the through slot 321b and to push against the fully-charged batteries, thereby causing the fully-charged batteries to pass through the press member 3311 from the discharge compartment 31 to the discharge compartment 31, thereby causing the fully-charged battery flows out of the discharging port 312a of the discharge compartment 31 through the press member 3311 to the outside of the chamber of the discharge compartment 31.

wherein the toggle plate 3321a extends along the width direction YY′ of the battery charging case 1; when the toggle plate 3321a is an elastic plate, one end of the toggle plate 3321a away from the discharging port 312a of the discharge compartment 31 is fixedly connected to the side wall of the discharge compartment 31; when the toggle plate 3321a is a rigid plate, the toggle plate 3321a away from the discharging port of the discharge compartment 31 312a, one end of the toggle plate 3321a is rotationally connected to the side wall of the discharge compartment 31. When the number of the toggle flanges 3321b is one, the one toggle flange 3321b is an elongate flange extending along the width direction YY′ of the battery charging case 1; when the number of the toggle flanges 3321b is a plurality of toggle flanges 3321b is an elongate flange extending along the width direction YY′ of the battery charging case 1, and the plurality of toggle flanges 3321b is an elongate flange extending along the width direction YY′ of the battery charging case 1. The multiple toggle flanges 3321b are elongate flanges extending along the width direction YY′ of the battery charging case 1, and the multiple elongate flanges are arranged in an M-row*N-column matrix along the length direction XX′ of the battery charging case 1 and the width direction YY′ of the battery charging case 1. The toggle flange 3321b may, but is not limited to, form an integral structure with the toggle plate 3321a by injection molding or 3D printing.

By designing the toggle plate 3321a, the toggle plate 3321a is used to carry the toggle flange 3321b and realizes a rotational connection with the press member 3311 by means of the connecting member 3322; when the pressing force is not applied to the press member 3311, the toggle flange 3321b is embedded in the through slot 321b of the first carrier plate 321; when the pressing force is applied to the press member 3311, the pressing flange 3321b is embedded in the through slot 321b of the first carrier plate 321; when the pressing force is applied to the press member 3311, the When the pressing force is applied to the press member 3311, the press member 3311 rotates, and the press member 3311 rotates to drive the toggle plate 3321a rotationally connected thereto to rotate in a direction away from the bottom wall of the discharge compartment 31, so as to cause the toggle flange 3321b embedded in the through slot 321b of the first carrier plate 321 to extend outward from the through slot 321b and to push against the fully-charged battery carried on the said first carrier plate 321 so that the fully-charged battery will be pushed against the through slot 321b by the toggle flange 3321b. the fully charged battery rolls toward the discharge port 312a of the discharge compartment 31 under the pushing force of the toggle flange 3321b and flows out of the discharge port 312a of the discharge compartment 31 through the press member 3311 to the outside of the chamber of the discharge compartment 31.

Specifically, the toggle member 3321 further comprises a first rotating shaft 3323, the first rotating shaft 3323 being provided at an end of the toggle plate 3321a away from the discharging port 312a of the discharge compartment 31, and the toggle plate 3321a is rotationally connected to a side wall of the inner discharge compartment 312 via the first rotating shaft 3323, so as to facilitate the rotation of the toggle plate 3321a towards a bottom wall of the discharge compartment 31 in a direction of moving the toggle plate 3321a away from the bottom wall of the discharge compartment 31 while the press member 3311 is pressed. This facilitates rotation of the toggle plate 3321a in a direction away from the bottom wall of the discharge compartment 31 under the driving of the press member 3311 so that the toggle flange 3321b pushes against a fully charged battery carried on the first carrier plate 321.

Further, the discharging compartment 31 includes a discharging outer compartment 311 and a discharging inner compartment 312; the discharging outer compartment 311 has an opening 311a connected to the chamber of the discharging outer compartment 311; the discharging inner compartment 312 is used for storing fully charged batteries, the discharging inner compartment 312 has the abovementioned discharge port 312a, and the discharge port 312a of the discharging inner compartment 312 is provided in correspondence with the opening 311a of the discharging outer compartment 311 The discharging inner compartment 312 is embedded in the chamber of the discharging outer compartment 311 by penetrating the opening 311a of the discharging outer compartment 311, and the discharging inner compartment 312 is extendable and retractable in a direction perpendicular to the plane in which the opening 311a of the discharging outer compartment 311 is located, so that the discharging inner compartment 312 has a first state in which the discharging inner compartment 312 is stowed inside the chamber of the discharging outer compartment 311, and a second state in which it is completely protruding out of the chamber of the discharging outer compartment 311 the second state in which the discharge compartment 311 is completely protruding out of the chamber of the discharge compartment 311.

Wherein, the outer discharge compartment 311 serves as an outer shell of the discharge compartment 31; the outer contour shape of the outer discharge compartment 311 may be, but is not limited to, rectangular-like or cylindrical-like; and the material from which the outer discharge compartment 311 is prepared may be, but is not limited to, PC (polycarbonate).

The shape of the opening 311a may, but is not limited to, be circular or rectangular.

The discharge inner compartment 312 serves as an inner shell of the discharge compartment 31; the outer contour shape of the discharge inner compartment 312 may be, but is not limited to, rectangular-like or cylindrical-like; and the material from which the discharge inner compartment 312 is prepared may be, but is not limited to, PC (Polycarbonate).

The inner discharge chamber 312 is embedded in the chamber of the outer discharge chamber 311 through the opening 311a, i.e., the outer discharge chamber 311 nests the inner discharge chamber 312 so that the discharge chamber 31 forms an inner and outer nested double shell structure. It is to be noted that the discharging outer compartment 311 has an feeding port for fully charged batteries to flow into the chamber of the discharging inner compartment 312, and the discharging inner compartment 312 has an feeding port for fully charged batteries to flow into the chamber of the discharging inner compartment 312, the feeding port of the discharging outer compartment 311 being disposed opposite the feeding port of the discharging inner compartment 312, so that fully charged batteries exiting the feeding port of the battery charging module 20 of the battery charging case 1 are sequentially disposed from the discharging outer compartment 311 to the discharging inner compartment 311 in a manner that is consistent with the discharging outer compartment 311 batteries flowing from the discharge port of the charging module 20 of the battery charging box 1 flow sequentially from the feeding port of the discharging outer compartment 311 and the feeding port of the discharging inner compartment 312 into the chamber of the discharging inner compartment 312.

The discharge compartment 312 is capable of telescoping in a direction perpendicular to the plane where the opening 311a is located so that the discharge compartment 312 has a first state in which the discharge compartment 312 is stowed inside the chamber of the discharge compartment 311 and a second state in which the discharge compartment 312 is completely extended outside the chamber of the discharge compartment 311. The discharge compartment 312 is capable of moving in a direction perpendicular to the plane of the opening 311a in a direction close to the discharge compartment 311 so that the discharge compartment 312 is stowed inside the chamber of the discharge compartment 311 in the above-described first state, wherein a user can take a fully charged battery from the discharge compartment 312 at a time, and the discharge compartment 312 is capable of moving in a direction perpendicular to the plane of the opening 311a in a direction far away from the chamber of the discharge compartment 311 in a direction far away from the chamber of the discharge compartment 311 in a direction far away from the chamber of the discharge compartment 313. The discharging inner compartment 312 can move in a direction perpendicular to the plane of the opening 311a in a direction away from the discharging outer compartment 311 so that the discharging inner compartment 312 completely extends out of the chamber of the discharging outer compartment 311 and is in the above-described second state, at which time the user can take a plurality of, or even all, fully charged batteries from the discharging inner compartment 312 at one time. The discharging inner compartment 312 may be switched between the above-described first state and the above-described second state relative to the discharging outer compartment 311 to satisfy the user's need to take different numbers of fully charged batteries from the discharging inner compartment 312 at one time.

Specifically, the side plates 3121 of the discharge inner compartment 312 are removable on a side intersecting the plane where the discharging port 312a is located. Wherein, the discharge inner compartment 312 includes two side plates 3121 extending along the width direction YY′ of the battery charging case 1, wherein one of the side plates 3121 may be, but is not limited to, being removable by at least one of screwing, snapping, or plugging. When the feeding inner compartment 312 moves in a direction perpendicular to the plane of the opening 311a away from the discharging outer compartment 311 and completely extends out of the chamber of the discharging outer compartment 311 so as to be in the above-described second state, then the user may first remove one side plate 3121 of the feeding inner compartment 312, and then multiple or even all of the fully-charged batteries may be taken out of the feeding inner compartment 312 at one time.

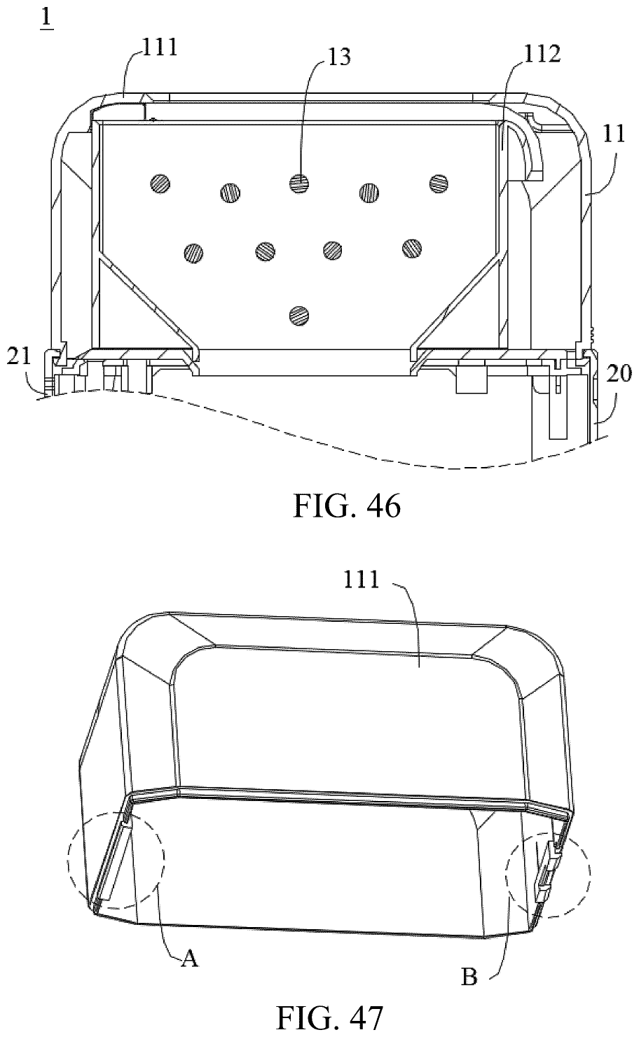

As shown in FIGS. 45-FIG. 46, the feeding module 10 includes a feeding compartment 11, the feeding compartment 11 includes a feeding outer compartment 111 and a feeding inner compartment 112 for storing batteries to be charged, the feeding opening of the feeding outer compartment 111 and the feeding opening of the feeding inner compartment 112 are provided in correspondence, the feeding outer compartment 111 covers the feeding inner compartment 112 and is connected to the charging compartment 21 of the charging module 20 by a snap-fit connection to hold the feeding inner compartment 112 against and positioned in the charging compartment 112. 112 against the charging compartment 21 of the feeding module 20, and the discharging port of the feeding inner compartment 112 is connected to the feeding port of the compartment body 211.

Wherein, the feeding compartment 11 serves as a housing for the feeding module 10.

The feed outer compartment 111 serves as an outer shell of the feed compartment 11; the outer contour shape of the feed outer compartment 111 may be, but is not limited to, rectangular or cylindrical; and the preparation material of the feed outer compartment 111 may be, but is not limited to, PC (polycarbonate).

The feeding inner compartment 112 serves as an inner shell of the feed compartment 11; the outer contour shape of the feeding inner compartment 112 may, but is not limited to, be rectangular or cylindrical; the material used in the preparation of the feeding inner compartment 112 may, but is not limited to, be PC (Polycarbonate).

The inlet of the feed outer compartment 111 is provided in correspondence with the inlet of the feed inner compartment 112, so that the batteries to be charged flow into the chamber of the feed inner compartment 112 sequentially from the inlet of the feed outer compartment 111 and the inlet of the feed inner compartment 112.

The feeding outer compartment 111 is connected to the charging compartment 21 of the feeding module 20 by means of a snap-fit connection to clamp and fix the feeding inner compartment 112 embedded in the cavity thereof between it and the charging compartment 21 of the charging module 20, and the feeding inner compartment 112 may be fixed in a relative position to the charging compartment 21 of the charging module 20 by means of a resisting force of the feeding outer compartment 111.

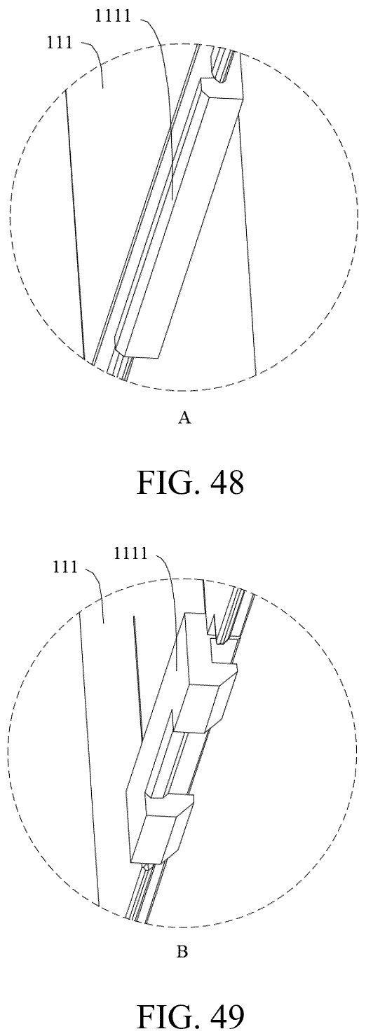

Specifically, as shown in FIGS. 46-FIG. 49, the edge of the feeding outer compartment 111 near the side of the charging compartment 21 of the charging module 20 is provided with at least one of the card block 1111 and the card slot (not shown in the FIGS.), the edge of the charging compartment 21 of the charging module 20 near the side of the feeding outer compartment 111 is provided with at least the other of the card block 1111 and the card slot, and the feeding outer compartment 111 and the charging compartment of the charging module 20 The feeding outer compartment 111 and the charging compartment 21 of the charging module 20 are relatively fixed in position between them by means of a snap-fit connection between the card block 1111 and the card slot. The card block 1111 may be provided on both sides of the feeding outer compartment 111 along the width direction YY′ of the battery charging compartment 1, and the corresponding card slot is provided on both sides of the charging compartment 21 of the charging module 20 along the width direction YY′ of the battery charging compartment 1, at which time the feeding outer compartment 111 and the charging compartment 21 of the charging module 20 are fixed to each other by the snap-fit connection of the card block 1111 and the card slot width direction YY′ of the battery charging case 1 to realize a snap-fit connection. The card block 1111 may also be provided on both sides of the feeding outer compartment 111 along the length direction XX′ of the battery charging case 1, and the corresponding slot is provided on both sides of the charging compartment 21 of the charging module 20 along the length direction XX′ of the battery charging compartment 1. At this time, the feeding outer compartment 111 is connected with the charging compartment 21 of the charging module 20 along the length direction XX′ of the battery charging compartment 1, and the charging compartment 21 of the charging module 20 is connected with the charging compartment 21 of the charging module 20 along the width direction YY′ length direction XX′ of the battery charging case 1 to realize a snap-fit connection. The card block 1111 may be provided on both sides of the feeding outer compartment 111 along the width direction YY′ of the battery charging case 1 and on both sides of the feeding outer compartment 111 along the length direction XX′ of the battery charging case 1, and the corresponding slot is provided on both sides of the charging compartment 21 of the charging module 20 along the width direction YY′ of the battery charging case 1. The corresponding slots are provided on both sides of the charging compartment 21 of the charging module 20 along the width direction YY′ of the battery charging case 1, and on both sides of the charging compartment 21 of the charging module 20 along the length direction XX′ of the battery charging case 1, wherein the feeding module 111 is provided on both sides of the charging compartment 21 of the charging module 20 along the width direction YY′ of the battery charging case 1, as well as the battery charging case 1. charging box 1 in the length direction XX′. It is to be noted that the card block 1111 may be, but is not limited to, formed into a one-piece structure with the feeding outer compartment 111 and the charging compartment 21 of the charging module 20 by means of injection molding or 3D printing.

The feeding outer compartment 111 sets the feeding inner compartment 112 so that the feeding compartment 11 forms an inner and outer nested double shell structure, which can effectively increase the structural strength of the feeding compartment 11 for the purpose of enhancing the overall structural strength of the feeding module 10.

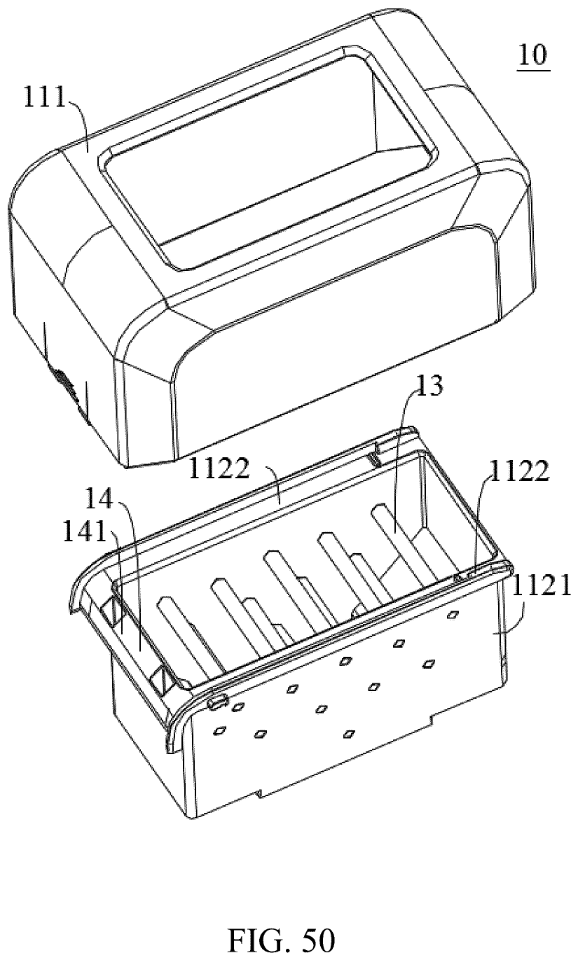

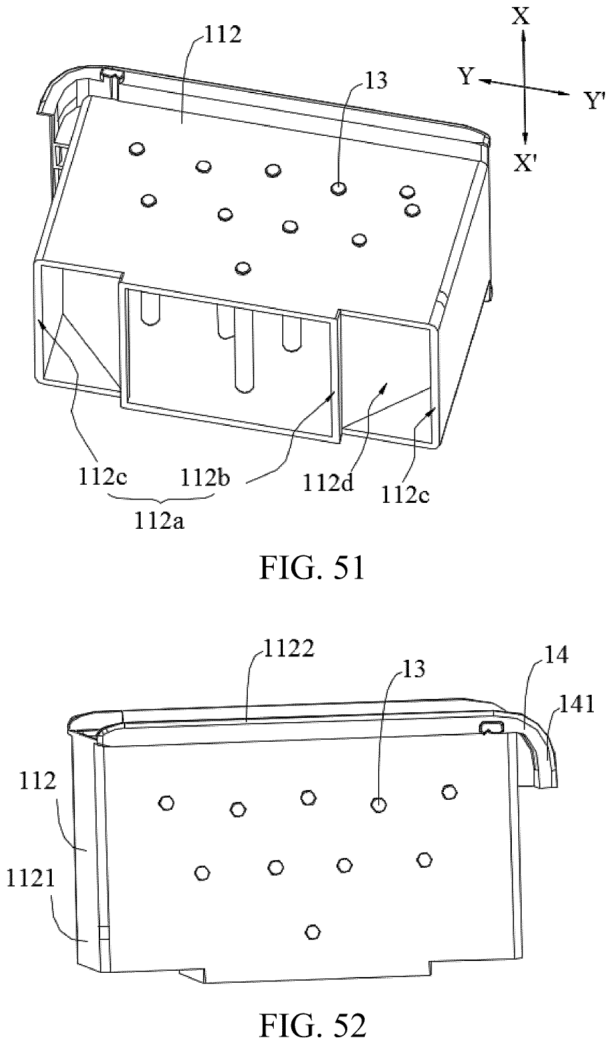

Further, as shown in FIGS. 50-FIG. 51, the feed inner compartment 112 has a bottom surface 112a disposed backwardly to the feed inlet of the feed outer compartment 111, the bottom surface 112a includes a first surface 112b and a second surface 112c, the first surface 112b is disposed farther away from the feed inlet of the feed outer layer as compared to the second surface 112c to form a step at the bottom of the feed inner compartment 112, the feed outlet of the feed inner compartment 112 is located at the first surface 112a, and the feed inlet is located at the bottom of the feed outer layer 112. When the feeding outer compartment 111 is snap-coupled with the charging compartment 21 of the charging module 20, the discharging portion of the feeding compartment 112 extends into the feeding port of the charging compartment 21 of the charging module 20, and the second surface 112c is used to contact with the outer surface of the charging compartment 21 of the charging module 20 to form a point contact, a line contact, or a surface contact, effectively enhancing the feeding stability of the inner compartment 112 placed on the charging compartment 21 of the charging module 20.

Wherein the first surface 112b and/second surface 112c may be planar, curved, or a combination of planar and curved surfaces. The first surface 112b and the second surface 112c are spaced apart to form a height difference therebetween thereby forming a step structure at the bottom of the feed inner compartment 112, with both the first surface 112b and the second surface 112c serving as step surfaces. When the feeding compartment 111 is snap-fit connected to the charging compartment 21 of the charging module 20, the feeding compartment 112 is positioned in the charging compartment 21 of the charging module 20 under the action of the resisting force of the feeding compartment 111, and the portion of the discharging portion of the feeding compartment 112 protrudes out of the plane of the second surface 112c described above so as to be embedded in the feeding portion of the charging compartment 21 of the charging module 20, so that the batteries to be charged are capable of flow out of the discharging port of the feeding inner compartment 112 outside the chamber of the feeding inner compartment 112 and flow into the chamber of the charging compartment 21 from the feeding port of the charging compartment 21 of the charging module 20.

Further, the number of second surfaces 112c is two, and the two second surfaces 112c are disposed on both sides of the first surface 112b along the width direction YY′ of the battery charging case 1. By dividing the two second surfaces 112c on both sides of the first surface 112b along the width direction YY′ of the battery charging compartment 1, when the feeding outer compartment 111 is snap-coupled with the charging compartment 21 of the charging module 20, the feeding inner compartment 112 is positioned in the charging compartment 21 of the charging module 20 under the action of the resisting force of the feeding outer compartment 111, and at this time both second surfaces 112c are both pressed against the outer surface of the charging compartment 21 of the charging module 20, increasing the contact area between the feeding inner compartment 112 and the charging compartment 21 of the charging module 20, so that the charging compartment 21 of the charging module 20 provides a more effective support for the feeding inner compartment 112.

Further, the second surface 112c is planar, and the second surface 112c is provided with hollowing grooves 112d, so that when the feeding outer compartment 111 is snap-fit connected with the charging compartment 21 of the charging module 20, the feeding inner compartment 112 is positioned in the charging compartment 21 of the charging module 20 under the action of the resisting force of the feeding outer compartment 111, and at this time, both of the second surfaces 112c resist and form face contact with the outer surface of the charging compartment 21 of the charging module 20 surface of the charging module 20 and form a face contact, so that the charging compartment 21 of the charging module 20 provides support for the feeding inner compartment 112, so that the feeding inner compartment 112 can better resist the charging compartment 21 of the charging module 20 under the action of the resisting force of the feeding outer compartment 111, thereby further effectively enhancing the stability of the feeding inner compartment 112 placed on the charging compartment 21 of the charging module 20. The hollowing groove 112d is also equivalent to a reinforcing bar capable of strengthening the structural strength of the bottom of the feeding inner compartment 112, so as to enhance the overall structural strength of the feeding inner compartment 112, and to a certain extent serve the purpose of saving materials and reducing costs.

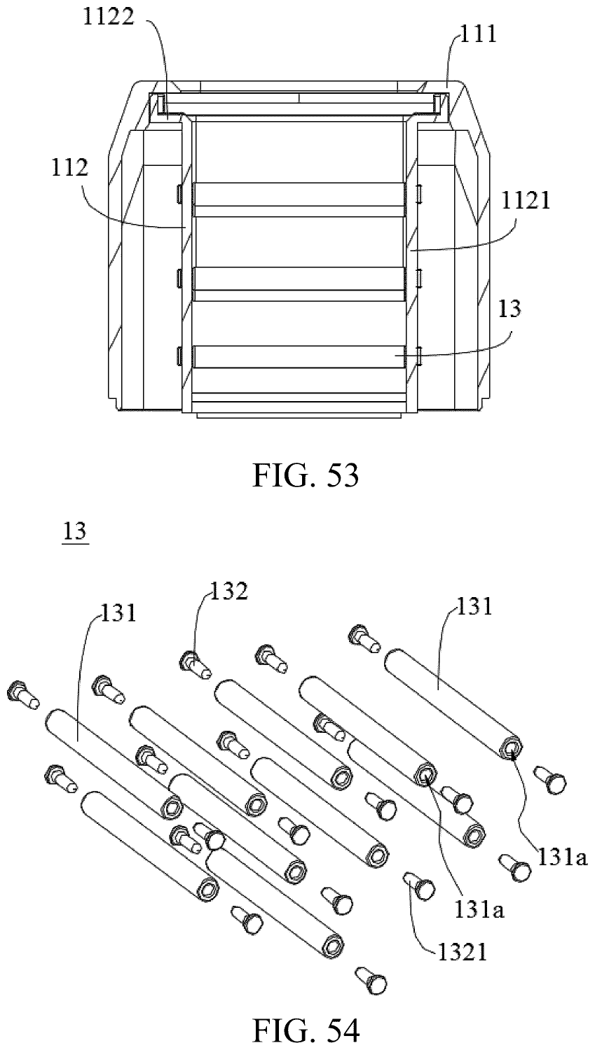

Further, as shown in FIGS. 52-FIG. 53, the compartment body 1121 includes a compartment body 1121 and an offsetting flange 1122; the compartment body 1121 is used for storing batteries to be charged; the offsetting flange 1122 is bent and coupled to the compartment body 1121 at an edge position where the inlet of the compartment body 1121 is located, and the end of the offsetting flange 1122 that is away from the compartment body 1121 rests against the inner surface of the inlet outer compartment 111, and the offsetting A gap is formed between an inner side of the flange 1122 and the inner surface of the feed outer compartment 111. The feeding module 10 further includes a spacer member (not shown in the figures), the spacer member being disposed within the gap and movable within the gap to open or close the feed opening of the compartment body 1121.

Wherein the offsetting flange 1122 extends along the width direction YY′ of the battery charging case 1, the offsetting flange 1122 may, but is not limited to, form a one-piece structure with the compartment body 1121 by means of injection molding or 3D printing. Along the width direction YY′ perpendicular to the battery charging case 1, the cross-section of the contact flange 1122 may be, but is not limited to, “L-shaped”or “C-shaped”.

The spacer, as a cover of the feeding module 10, can be used to cover the feed opening of the compartment body 1121 to prevent the batteries to be charged that flow into the chamber of the compartment body 1121 from flowing back out of the chamber of the compartment body 1121 through the feed opening of the compartment body 1121. The spacer member is movable relative to the compartment body 1121 within the gap, so that the feeding port of the compartment body 1121 switches between an open state and a closed state. It is to be noted that, since the feed port of the feed outer compartment 111 is provided in correspondence with the feed port of the compartment body 1121, the spacer member moves within the gap to open the feed port of the compartment body 1121 at the same time as it corresponds to opening the feed port of the feed outer compartment 111, at which time batteries to be charging compartments can flow into the chamber of the compartment body 1121 in sequence from the feed port of the feed outer compartment 111, the feed port of the compartment body 1121, and so on; similarly, the spacer member can move relative to the compartment body 1121 to switch between the open state and the closed state. Inside the chamber; similarly, while the spacer member moves within the gap to cover the inlet opening of the compartment body 1121, it also corresponds to cover the inlet opening of the feed outer compartment 111, at which time the batteries to be charging compartments cannot flow into the chamber of the compartment body 1121 from the inlet opening of the feed outer compartment 111 and the inlet opening of the compartment body 1121 in sequence. When the offsetting flange 1122 extends along the width direction YY′ of the battery charging case 1, the gap formed between the inner side of the offsetting flange 1122 and the inner surface of the feed outer compartment 111 also extends along the width direction YY′ of the battery charging case 1, and at this time, the partition member moves within the gap along the width direction YY′ of the battery charging case 1 to open or close the inlet opening of the compartment body 1121. It is worth mentioning that the provision of the barrier member can, on the one hand, prevent the batteries to be charged that flow into the chamber of the compartment body 1121 from flowing out of the chamber of the compartment body 1121 from the feeding port of the compartment body 1121, and on the other hand, it can also prevent the impurities, such as for example dust, from falling into the chamber of the compartment body 1121.

Further, the spacer member includes a flexible spacer, and the flexible spacer is movable within the gap to open or close the inlet opening of the compartment body 1121. The flexible spacer can be supported on the inner side of the offsetting flange 1122, and the user pushes or pulls the flexible spacer to open or close the inlet opening of the compartment body 1121, which is easy and convenient to operate. The spacer may also include a rigid spacer, the rigid spacer being disposed within the gap and slidably connectable with the compartment body 1121 to open or close the inlet opening of the compartment body 1121.

Further, the feeding module 10 further includes a support structure 14 for carrying the flexible baffle, the support structure 14 being connected to the compartment body 1121 and the support structure 14 being disposed on at least one side of the feed opening of the compartment body 1121 along the direction of movement of the flexible baffle.

Wherein, the support structure 14 is used to carry the flexible baffle plate to support the flexible baffle plate; the support structure 14 may include a carrier roller, the carrier roller is fixedly connected to the compartment body 1121, and the flexible baffle plate is disposed on an outer surface of the carrier roller, so that rolling friction is generated between the flexible baffle plate and the carrier roller when the flexible baffle plate moves in the gap. When the flexible baffle plate opens and covers the inlet of the compartment body 1121 in a single-opening type, the number of the flexible baffle plate is one, and the number of the support structure 14 is one, and at this time, along the movement direction of the flexible baffle plate, the one support structure 14 is disposed on a side of the compartment body 1121; when the flexible baffle plate opens and covers the inlet of the compartment body 1121 in a double-opening type, the number of the flexible baffle plate is two, the number of the support structure 14 is two, and at this time, the number of the flexible baffle plate is two, and the number of the support structure 14 is two, and the number of the support structure 14 is two. When the flexible baffles are opened and closed in the inlet opening of the compartment body 1121 in a double-opening manner, the number of flexible baffles is two and the number of supporting structures 14 is two, and at this time, along the movement direction of the flexible baffles, the two supporting structures 14 are disposed on both sides of the compartment body 1121.

Specifically, the support structure 14 includes a support plate 141, one end of the support plate 141 is connected to the edge of the compartment body 1121 near the inlet side of the feeding port of the feed compartment 111, and the support plate 141 is bent toward the inlet side of the compartment body 1121, so as to enable the flexible baffle plate to be adhered to the support plate 141 to a greater extent, and to increase the contact area between the flexible baffle plate and the support plate 141, thus effectively enhancing the flexibility of the flexible baffle plate on the inlet side of the compartment body 1121, and effectively improving the flexibility of the flexible baffle plate on the inlet side of the compartment body 1121 effectively improving the stability of the movement of the flexible partition plate within the gap. Wherein, the support plate 141 may be, but is not limited to, formed into a one-piece structure with the feed inner compartment 112 by means of injection molding or 3D printing.

Further, as shown in FIG. 50, FIG. 51, and FIG. 54, the feeding module 10 further comprises a guiding structure 13, the guiding structure 13 being disposed within the chamber of the feeding inner compartment 112 and being detachably connected to the feeding inner compartment 112.

wherein the guiding structure 13 has a guiding effect on the batteries to be charged flowing into the chamber of the feeding inner compartment 112, and the batteries to be charged come into contact with the guiding structure 13, and under the action of the guiding structure 13, the direction of the movement of the batteries to be charged changes, so that the trajectory of the batteries to be charged in the chamber of the feeding inner compartment 112 is altered, so that the batteries to be charged are evenly disposed in the chamber of the feeding inner compartment 112 evenly disposed within the chamber of the feeder inner compartment 112. The guiding structure 13 may be, but is not limited to, detachably coupled to the feed compartment 112 by at least one of screwing, snapping, or plugging. The guiding structure 13 may include a conveyor belt when the guiding effect of the guiding structure 13 on the battery to be charged is dynamic, and the guiding structure 13 may include a guiding slot when the guiding effect of the guiding structure 13 on the battery to be charged is static. When the guiding structure 13 includes the above-mentioned conveyor belts or guide slots, the number of conveyor belts or guide slots may be a plurality of conveyor belts or guide slots, and the conveyor or extension directions of the plurality of conveyor belts or guide slots are different and pre-designed, so that different batteries to be recharged are guided to different positions under the action of different conveyor belts or guide slots, thereby realizing an even row of batteries to be recharged in the chamber of the feeding inner compartment 112.

Further, a plurality of through holes are provided on the first side and the second side of the feeding inner compartment 112 disposed opposite to each other along the length direction XX′ of the battery charging case 1. The guiding structure 13 includes a plurality of guide rollers 131 and a plurality of fastening units 132; the guide rollers 131, the fastening units 132, the through-holes on the first side and the through-holes on the second side are provided one-to-one, and each fastening unit 132 is threaded through the corresponding first through-hole and the corresponding second through-hole and connected to the corresponding guide rollers 131 so as to position all of the guide rollers 131 in the feeding inner compartment 112 in accordance with the preset arrangement. The inner compartment 112.

Wherein, the guide rollers 131 are arranged in a preset arrangement, wherein the preset arrangement may be a regular matrix arrangement of the plurality of guide rollers 131 in M rows*N columns, or an irregular arrangement of the plurality of guide rollers 131 in M rows with the number of guide rollers 131 in each row decreasing row by row in comparison with the number of guide rollers 131 in the previous row. It is worth mentioning that the guide rollers 131 are capable of changing the direction of movement of the batteries to be charged on the one hand, and on the other hand are equivalent to reinforcement bars capable of reinforcing the structural strength of the feeding inner compartment 112.

Specifically, each guide roller 131 is provided with a hole 131a on both end faces of the guide roller 131; each fastening unit 132 includes two snap pins 1321, one of which is provided with a first through-hole and is engaged with the hole 131a on one of the end faces of the guide roller 131, and the other snap pin 1321 is provided with a second through-hole and is engaged with the hole 131a on the other end face of the guide roller 131, so as to position the guide roller 131 in the feeding inner compartment 112. By designing snap holes 131a on both ends of the guide roller 131, the two snap pins 1321 are provided with the first through-hole and the second through-hole and snap to the snap holes 131a on both ends of the guide roller 131 to facilitate installation and removal of the guide roller 131 with the feeding inner compartment 112.

What is claimed is:

1. A battery charging case, comprising:
a feeding module, used to accommodate a plurality of batteries to be charged;
a charging module, used to charge the plurality of batteries to be charged, comprising a charging compartment, a screening assembly, and a classification assembly; the charging compartment comprises a compartment body, a first bracket, and a second bracket; a feeding port of the compartment body is connected to a discharging port of the feeding module; the first bracket is installed in a chamber of the compartment body and comprises a battery installation through slot for accommodating the plurality of batteries to be charged; the screening assembly is installed on the first bracket and is located at a discharging side of the battery installation through slot, the screening assembly is configured to move along a width direction of the battery charging case to screen the plurality of batteries to be charged which fall into the battery installation through slot; the second bracket is installed in the chamber of the compartment body and is detachably connected to the first bracket, the second bracket is further away from the feeding port of the compartment body than the first bracket and comprises a channel for the circulation of a plurality of fully charged batteries as well as waste batteries, the channel is located below the battery installation through slot; the classification assembly is installed on the second bracket and is located at a discharging side of the second bracket, the classification assembly is configured to transfer the plurality of fully charged batteries as well as waste batteries flowing out of the channel to different areas;
a discharging module, used to accommodate the plurality of fully charged batteries, a feeding port of the discharging module is connected to a discharging port of the charging module.

2. The battery charging case of claim 1, wherein the second bracket is detachably connected to the first bracket by means of locking screws.

3. The battery charging case of claim 1, wherein the screening assembly comprises a screening port for the plurality of batteries to be charged to flow through; the charging module further comprises a second drive assembly, which is installed on the first bracket and is drivingly connected to the screening assembly;
wherein the second drive assembly is configured to drive the screening assembly to move along the width direction of the battery charging case; when the screening assembly moves to the screening port to align with the battery installation through slot, the plurality of batteries to be charged that meet model requirements pass through the screening port; when the screening assembly moves to the screening port to be offset from the battery installation through slot, the plurality of batteries to be charged that do not meet model requirements pass through the screening port.

4. The battery charging case of claim 3, wherein the screening assembly comprises:
a screening plate extending along the width direction of the battery charging case and sliding connected to the first bracket, the screening plate comprises the screening port;
a transmission rack extending along the width direction of the battery charging case and fixedly connected to the screening plate;
wherein the second drive assembly is drivingly connected to the transmission rack and is configured to drive the screening plate to move along the width direction of the battery charging case through the transmission rack.

5. The battery charging case of claim 4, wherein the second drive assembly comprises:
a second motor, installed on the first bracket;
a transmission gear, which is fixedly connected to a drive shaft of the second motor and meshes with the transmission rack.

6. The battery charging case of claim 1, wherein the discharging side of the second bracket comprises a first opening for the plurality of fully charged batteries to flow through, and a second opening for the plurality of waste batteries to flow through;
wherein the classification assembly has a first classification state and a second classification state and switches between the first and second classification states, such that the plurality of fully charged batteries flow through the first opening in the first classification state, and the plurality of waste batteries flow through the second opening in the second classification state.

7. The battery charging case of claim 6, wherein the charging module further comprises a control assembly installed on the second bracket, the control assembly is electrically connected to the classification assembly to control the classification assembly to switch between the first classification state and the second classification state.

8. The battery charging case of claim 7, wherein the classification assembly comprises:
a third motor, installed on the second bracket and electrically connected to the control assembly;
a classification member, located at the discharging side of the second bracket and connected to a drive shaft of the third motor;
wherein in the first classification state, the control assembly controls the third motor to drive the classification member to rotate to block the second opening, to allow the plurality of fully charged batteries to flow through the first opening; in the second classification state, the control assembly controls the third motor to drive the classification member to rotate to block the first opening, to allow the plurality of waste batteries to flow through the second opening.

9. The battery charging case of claim 6, wherein the plane in which the first opening is located intersects the plane in which the second opening is located, and the plane in which the second opening is located is parallel to the horizontal plane;
the distance between the bottom surface of the channel and the plane in which the second opening is located gradually increases from a side close to the first opening to a side away from the first opening.

10. The battery charging case of claim 1, wherein the charging module further comprises:
a charging clamping structure, installed on the first bracket corresponding to the battery installation through slot,
a first drive assembly, drivingly connected to the charging clamping structure and configured to move along the width direction of the battery charging case to drive the charging clamping structure to move along a length direction of the battery charging case, so as to clamp and charge the plurality of batteries to be charged.

11. The battery charging case of claim 10, wherein the charging clamping structure comprises:
a clamping assembly, installed on the first bracket corresponding to the battery installation through slot and drivingly connected to the first drive assembly;
a charging assembly, installed on the clamping assembly and comprises a charging terminal for electrical connection with the electrodes of the plurality of batteries to be charged;
wherein the first drive assembly is configured to move along the width direction of the battery charging case to drive the clamping assembly to move along the length direction of the battery charging case, such that the clamping assembly clamps the plurality of batteries to be charged and maintains contact between the charging terminal of the charging assembly and the electrodes of the plurality of batteries to be charged.

12. The battery charging case of claim 11, wherein the clamping assembly comprises:
two grippers, installed on the first bracket corresponding to the battery installation through slot, and the charging assembly is installed on the two grippers;
two connection units, connected individually with two grippers, and two grippers are respectively drivingly connected to the first drive assembly through the corresponding connection units;
wherein the first drive assembly is configured to move along the width direction of the battery charging case, and drive two grippers to approach each other along the length direction of the battery charging case through the connection unit, so that two grippers clamp the plurality of batteries to be charged from both ends and make the charging terminal of the charging assembly contact the electrodes of the plurality of batteries to be charged.

13. The charging module of claim 13, wherein the charging assembly comprises:
two charging circuit boards, connected individually to two grippers;
two charging terminal groups which serve as the charging terminals and are electrically connected individually to the two charging circuit boards;
wherein one of the charging terminal groups is used to make contact with the positive electrodes of the plurality of batteries to be charged, and the other charging terminal group is used to make contact with the negative electrodes of the plurality of batteries to be charged.

14. The battery charging case of claim 1, wherein the compartment body comprises a first opening for the plurality of fully charged batteries to flow through, a second opening for the plurality of waste batteries to flow through, and a waste discharging port connected to the chamber of the compartment body; and the charging module further comprises:
a base, embedded at the bottom of the compartment body and detachably connected to the compartment body, a discharging port of the base is connected to the first opening and used for the plurality of fully charged batteries to flow outside the chamber of the compartment body;
a waste compartment, used to store the plurality of waste batteries, and embedded in the chamber of the compartment body through the waste discharging port and connected to the base, a feeding port of the waste compartment is connected to the second opening and used for the plurality of waste batteries to flow into a chamber of the waste compartment;
wherein the waste compartment can perform concertina movement in a direction perpendicular to the plane of the waste discharging port so that the waste compartment has a storage state in which it is retracted inside the chamber of the compartment body and an extended state in which it extends outside the chamber of the compartment body.

15. The battery charging case of claim 14, wherein the base is detachably connected to the compartment body by means of screwing and/or snap-fitting.

16. The battery charging case of claim 1, wherein the discharging module comprises:
a discharging compartment comprising a feeding port and a discharging port, the feeding port of the discharging compartment is connected to the discharging port of the charging module;
a carrier structure, at least partially disposed within a chamber of the discharging compartment and connected to the discharging compartment, the carrier structure is configured to carry the plurality of fully charged batteries flowing from the discharge port of the charging module in layers;
a discharge structure comprising a press assembly and a toggle assembly, the press assembly is provided on a discharge side of the carrier structure, is connected to the discharging compartment, and partially protrudes out of the chamber of the discharging compartment through the discharge port of the discharging compartment, the toggle assembly is disposed within the chamber of the discharging compartment and connected to the press assembly and to the discharging compartment;
wherein the press assembly is configured to rotate to drive the toggle assembly so that the toggle assembly drives the plurality of fully charged batteries to flow out of the discharge port of the discharging compartment into the chamber of the discharging compartment.

17. The battery charging case of claim 16, wherein the carrier structure comprises:
a first carrier plate, provided within the chamber of the discharging compartment, an end of the first carrier plate away from the discharge port of the discharging compartment is connected to the side wall of the discharging compartment, an end of the first carrier close to the discharge port of the discharging compartment serves as the discharge side of the carrier structure;
a second carrier plate, further away from the base wall of the discharging compartment than the first carrier plate and spaced from the first carrier plate to form a first interlayer for holding the plurality of fully charged batteries, the second carrier plate is connected to the side wall of the discharging compartment and comprises a notch through which the plurality of fully charged batteries carried on the second carrier plate can fall through the notch onto the first carrier plate.

18. The battery charging case of claim 1, wherein the feeding module comprises:
a feeding compartment, comprising a feeding outer compartment and a feeding inner compartment for storing the plurality of batteries to be charged, a feeding port of the feeding outer compartment is provided corresponding to a feeding port of the feeding inner compartment, the feeding outer compartment covers the feeding inner compartment and is connected to the charging compartment of the charging module by a snap-fit connection to hold the feeding inner compartment against the charging compartment of the charging module, and a discharge port of the feeding inner compartment is connected to the feeding port of the compartment body.
